(19) United States
(12) Patent Application Publication
(10) Pub. No.: US 2010/0014831 A1
(43) Pub. Date: Jan. 21, 2010

(54) Recording device, method of controlling recording device, information terminal, information communications system, and storage medium

(75) Inventor: Ikuo Nakano, Osaka (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 12/460,393

(22) Filed: Jul. 16, 2009

(30) Foreign Application Priority Data
Jul. 18, 2008 (JP) 2008-187770

(51) Int. Cl. H04N 5/91

(52) U.S. Cl. 386/83; 386/E05.001

(57) ABSTRACT

A video recorder includes: a device-end transmission/reception section for receiving either recording schedule information or recording schedule command information representing a command to determine the recording schedule information from a personal information terminal capable of communicating with the video recorder; and a device information management section for setting up a terminal ID by which to identify the personal information terminal for either the recording schedule information received by the device-end transmission/reception section or the recording schedule information determined according to the recording schedule command information and managing the terminal ID and the recording schedule information in association with each other.

This nonprovisional application claims priority under 35 U.S.C. § 119(a) on Patent Application No. 2008-187770 filed in Japan on Jul. 18, 2008, the entire contents of which are hereby incorporated by reference.

### TECHNICAL FIELD

The present invention relates to recording devices which readily enable the user to recognize the schedule information which he/she needs, as well as to associated methods of controlling a recording device, information terminals, information communications systems, and storage media.

### BACKGROUND ART

Recent years have seen successful utilization of video recorders based on a high-capacity storage medium, such as a hard disk or a DVD, in the recording of TV programs and like video data. Using such a device, one can record many programs and large amounts of video data. It is expected that in the years to come, we will witness utilization of recording devices based on a high-capacity storage medium with even greater capacity, such as Blu-ray® discs. The video recorder will be capable of recording more programs.

A high-capacity storage medium-based video recorder can record large numbers of programs as mentioned above. That creates a need for the user to select a desired one of the numerous recorded programs before any playback. If the video recorder stores the programs without grouping, the user will find it increasingly difficult to select a desired program as the number of recorded programs grows.

When the video recorder is used at home, for example, the video recorder may be used by two or more users. Programs recorded by different users reside together in the recorder, making it even more difficult for the users to select a desired program.

Patent Literatures 1 and 2, among others, address these problems by disclosing a high-capacity storage medium-based video recorder, capable of recording many programs, which even if used by two or more users can still let the users select a recorded program.

### Citation List

### Patent Literature 1

### Japanese Patent Application Publication, Tokukai, No. 2003-141851 (Publication Date: May 16, 2003)

### Patent Literature 2

### Japanese Patent Application Publication, Tokukai, No. 2006-229780 (Publication Date: Aug. 31, 2006)

Patent Literature 1 discloses an optical disc read/write device which associates recorded video content to users (who schedule actions) to enable each user to select a program he/she recorded even if many programs are recorded by many users. Specifically, the optical disc read/write device selects a user by recording, together with each set of program information, a user ID by which to identify the user who makes a recording of the program. Accordingly, the optical disc read/write device can play back or erase the program recorded by the selected user.

Furthermore, before allowing a recording, playback, or erasure of a program, the optical disc read/write device can check unique information that the user only knows, thus restricting recording, playback, and erasure of the program by other users.

Patent Literature 2 discloses a program recording device which enables a user to find a program from large numbers of recorded programs. Specifically, the program recording device generates a recorded program table by associating program information for the recorded ones of those programs which a user wants to record to an ID (for example, an email address) by which to identify the user and listing all this information in matrix form, so that the recorded program table can be displayed on a display device. The user can find a program he/she wants from the large numbers of recorded programs by consulting the recorded program table.

Apart from the email address, Patent Literature 2 also cites a name, a nickname, and other kinds of information by which the user can be identified as user IDs used in the program recording device. Patent Literature 2 cites a method of inputting the user ID to the device, a remote controller, or a mobile terminal (for example, a mobile phone) via a control section equipped with scheduling function, as a method by which the program recording device can receive the user ID. If the user does the inputting on the remote controller or the mobile terminal, the input information (user ID) is transmitted from the mobile terminal to the program recording device by infrared communications.

The technology in Patent Literatures 1 and 2 associates recorded video content to a user and to this end obtains a user ID (ID) by which to identify the user via the control section. In other words, in Patent Literatures 1 and 2, the device needs to receive user inputs on the control section provided in the recording device so as to generate the ID for use in establishing the association, which is inconvenient.

For example, in the technology in Patent Literature 2, an email address for an external electronic device with communications capability is obtained as an ID. It is time consuming to enter the email address, and the user is required to perform complex operation.

Put differently, the technology in Patent Literatures 1 and 2 involves a mechanism where the ID by which to identify the user is obtained through inputs from the user. Thus, the user is undesirably required to perform some operation so that the optical disc read/write device or the program recording device can obtain the ID.

The email address used in the program recording device of Patent Literature 2 is the one used for the mobile terminal to receive, for example, an email which reports termination of a recording to the mobile terminal or an email including the same reporting and a recorded program as an attachment. In other words, the technology does not assume that the email address used here would be used by the program recording device to identify the mobile terminal.

### SUMMARY OF INVENTION

The present invention, conceived in view of these problems, has an objective of providing a recording device which readily enables the user to recognize the schedule information which he/she needs, as well as providing an associated method of controlling a recording device, information terminal, information communications system, and storage medium.

A recording device in accordance with the present invention, to solve the problems, is characterized in that the device is a recording device recording a program according to schedule information for scheduling a recording of the program and includes:

device-end reception means for receiving either the schedule information or scheduling command information representing a command to determine the schedule information from an information terminal capable of communicating with the recording device;

setup means for setting up a terminal ID by which to identify the information terminal for either the schedule information received by the device-end reception means or the schedule information determined according to the scheduling command information; and

device management means for managing the terminal ID set up by the setup means and the schedule information in association with each other.

A method of controlling a recording device in accordance with the present invention, to solve the problems, is characterized in that the method is a method of controlling a recording device recording a program according to schedule information for scheduling a recording of the program and includes the steps of:

(a) receiving either the schedule information or scheduling command information representing a command to determine the schedule information from an information terminal capable of communicating with the recording device;

(b) setting up a terminal ID by which to identify the information terminal for either the schedule information received in step (a) or the schedule information determined according to the scheduling command information; and

(c) managing the terminal ID set up in step (b) and the schedule information in association with each other.

According to the configuration, in the recording device, the setup means sets up a terminal ID for either the schedule information received by the device-end reception means or the schedule information determined according to the scheduling command information. In other words, the setup means sets up a terminal ID for the schedule information to set up an terminal ID for the information terminal from which either the schedule information or the scheduling command information has been received. Then, the device management means manages the terminal ID either received or set up and the schedule information in association with each other.

Accordingly, the recording device can have, for example, a display device connected to the recording device display only the schedule information for the program of which the user has scheduled a recording, without having to have information on either the user who schedules the recording of the program or the information terminal used by the user obtained through inputs from the user on the information terminal. In other words, the recording device does not need to have the user who schedules the recording of the program using the information terminal perform any manipulation other than entering record scheduling commands; hence, the recording device can readily have the user recognize only the schedule information that he/she needs. The information terminal capable of communicating with the recording device is the mobile phone, PDA, etc. and assumed generally to be used alone by a particular person.

Additional objectives, advantages and novel features of the invention will be set forth in part in the description which follows, and in part will become apparent to those skilled in the art upon examination of the following or may be learned by practice of the invention.

### BRIEF DESCRIPTION OF DRAWINGS

FIG. 1 is a schematic block diagram of a video recorder and a personal information terminal in an information communications system in accordance with the present invention.

FIG. 2(a) is a schematic diagram of an information communications system in which a video recorder communicates with a personal information terminal; FIG. 2(b) is a schematic diagram of an information communications system 10 in which a video recorder communicates with two or more personal information terminals 2; and FIG. 2(c) is a schematic diagram of an information communications system in which two or more video recorders communicate with a personal information terminal.

FIG. 3 is a flow chart depicting, as an example, a video recording process implemented by the video recorder and the personal information terminal in the information communications system shown in FIG. 1.

FIG. 4 is a schedule management table, an example of a storage format for link information recorded in a device memory in the video recorder shown in FIG. 1.

FIG. 5 is an illustration of an example of a scheduled program list being displayed on the display device shown in FIG. 1.

FIG. 6 is an illustration of another example of a scheduled program list being displayed on the display device shown in FIG. 1.

FIG. 7 is an illustration of a change of a display screen in setting up a scheduled recording using an iEPG displayed on the display section in the personal information terminal shown in FIG. 1.

FIG. 8 is an illustration of a display screen on the display section in the personal information terminal shown in FIG. 1 and a display screen on the display device shown in FIG. 1 in setting up a scheduled recording via a G code input screen displayed on that display section.

FIG. 9 is an illustration of a change of a display screen in setting up a scheduled recording using an EPG displayed on the display device connected to the video recorder shown in FIG. 1.

FIG. 10 is a flow chart depicting, as an example, a playback process implemented by the video recorder and the personal information terminal in the information communications system shown in FIG. 1.

### DESCRIPTION OF EMBODIMENTS

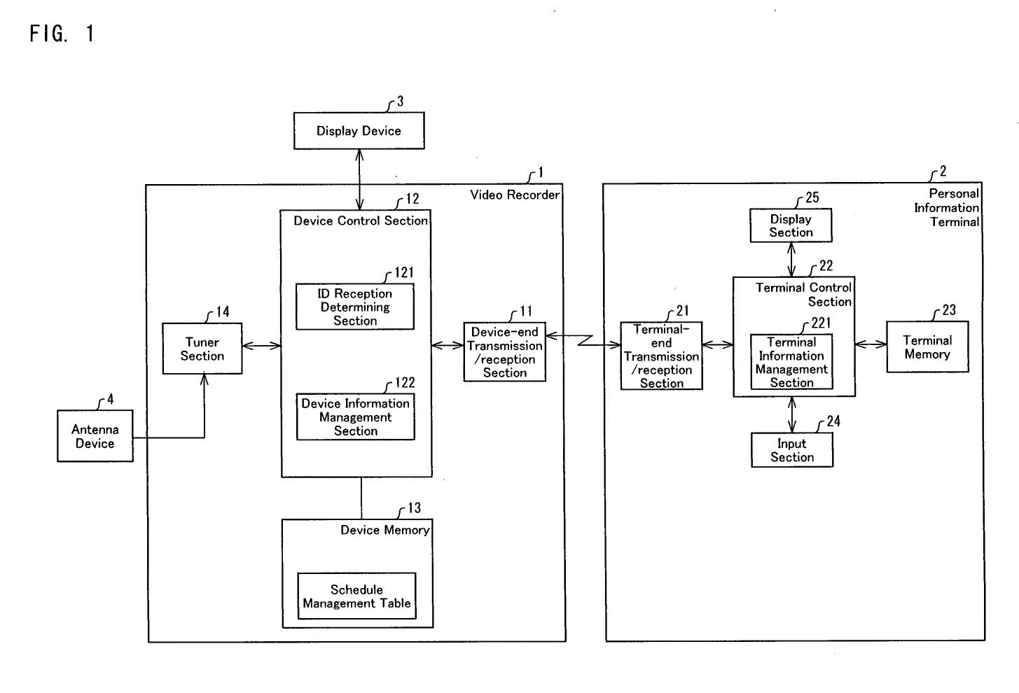

The following will describe an embodiment of the present invention in reference to FIGS. 1 to 10.

### Brief Description of Configuration of Information Communications System

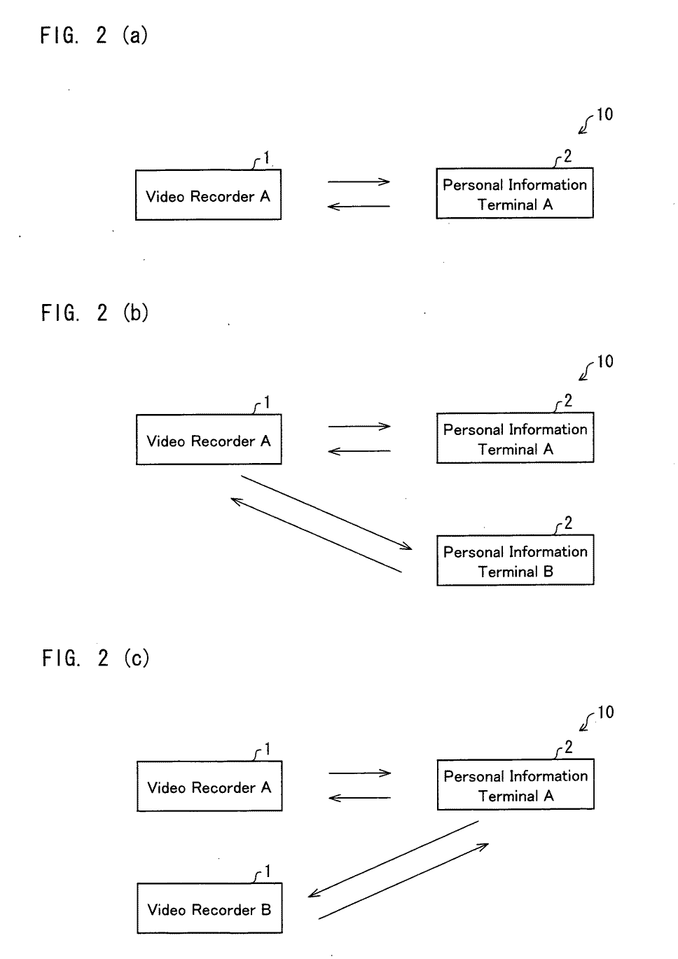

Referring to FIG. 2, an information communications system 10, containing a video recorder (recording device) 1 and a personal information terminal (information terminal) 2 which communicates with the video recorder 1, will be first described schematically in terms of its overall structure in accordance with the present invention. FIG. 2 is schematic diagrams of the information communications system 10 containing at least one video recorder 1 and at least one personal information terminal 2 which communicates with the video recorder 1 in accordance with the present invention. FIG. 2(a) shows the information communications system 10 in which a video recorder 1 communicates with a personal information terminal 2; FIG. 2(b) shows the information communications system 10 in which a video recorder 1 communicates with two or more personal information terminals 2; and FIG. 2(c) shows the information communications system 10 in which two or more video recorders 1 communicates with a personal information terminal 2.

In FIG. 2(a), the information communications system 10 includes a video recorder 1 and a personal information terminal 2. The video recorder 1 communicates with the personal information terminal 2 wirelessly, for example, by infrared: some other examples include ZigBee®, UWB (ultrawide band), Bluetooth®, wireless LAN (local area network), or Wibree.

The video recorder 1 stores program information (broadcast station, broadcast date and time, program title, etc.) for the programs of which the user wants to schedule a recording (timed recording) as recording schedule information (schedule information) and starts recording the program included in the recording schedule information on the broadcast date and time included in the recording schedule information. The video recorder 1 also plays back a recorded program in response to inputs from the user.

The personal information terminal 2 is a mobile device capable of communications with the video recorder 1. Examples include mobile phones, mobile PCs, PDAs (personal digital assistants), and like mobile terminals.

In the information communications system 10 according to the present embodiment, the user can give commands to the video recorder 1 via the personal information terminal 2 for actions, such as a scheduled recording of a program and a playback of a recorded program. The personal information terminal 2 may be configured to enable the user to give commands to the video recorder 1 for a recording of a program, various manipulations in a playback of a recorded program (e.g., fast forward, rewind, stop, and pause), and erasure of a recorded program.

The video recorder 1 specifies a terminal ID for the personal information terminal 2 based on the analysis of information received from the personal information terminal 2. The personal information terminal 2, when it has a terminal ID, transmits the terminal ID together with the recording schedule information to the video recorder 1.

FIG. 2(b) illustrates the information communications system 10 when a plurality (two in this case) of personal information terminals 2 (Personal Information Terminal A and Personal Information Terminal B) can communicate with a video recorder 1 (Video Recorder A). The video recorder 1 specifies respective terminal IDs for the plurality of personal information terminals 2.

FIG. 2(c) illustrates the information communications system 10 when a personal information terminal 2 (Personal Information Terminal A) can communicate with a plurality (two in this case) of video recorders 1 (Video Recorder A and Video Recorder B). Each video recorder 1 transmits a device ID to the personal information terminal 2.

Details will be given later about the specific configuration of the video recorder 1 and the personal information terminal 2 in the information communications system 10.

The information communications system 10 includes a display device 3 and an antenna device 4 as illustrated in FIG. 1.

The display device 3 includes a display section built around a liquid crystal display, a plasma display, an OLED display, or any equivalent device to display, for example, TV programs and EPGs (Electronic Program Guides) received by the video recorder 1 via the antenna device 4. The display device 3 also displays, for example, progress of processing (manipulation by the user) in the video recorder 1.

The display device 3 is connected to the video recorder 1 by, for example, an HDMI (High-Definition Multimedia Interface) or DVI (Digital Visual Interface) cable. The display device 3 may include analog RGB terminals, an i.Link Terminal®, a LAN terminal, or a like external connection terminal for network connection with the video recorder 1. For example, if the display device 3 has a LAN terminal, and the video recorder 1 has server functions, the video recorder 1 and the display device 3 are network-connected via a hub by DLNA standard.

The display device 3 according to the present embodiment is connected to the antenna device 4 via the video recorder 1. Alternatively, the display device 3 may be connected directly to the antenna device 4 to directly receive TV programs.

### Brief Description of Configuration of Video Recorder

Next, the configuration of the video recorder 1 which communicates with the personal information terminal 2 will be schematically described in reference to FIG. 1. FIG. 1 is a schematic block diagram of the video recorder 1 and the personal information terminal 2 in the information communications system 10 in accordance with the present invention. As illustrated in FIG. 1, the video recorder 1 includes a device-end transmission/reception section (device-end reception means) 11, a device control section 12, a device memory 13, and a tuner section 14.

The device-end transmission/reception section 11 is provided to enable communications with the personal information terminal 2 and transmits/receives information, such as recording schedule information, recording schedule command information (scheduling command information), terminal IDs, and personal IDs. The especially important role of the device-end transmission/reception section 11 is to receive the recording schedule command information including the recording schedule information or a command to determine the recording schedule information from the personal information terminal 2 which can communicate with the video recorder 1. The device-end transmission/reception section 11 also receives terminal-specific information that is unique to and representative of the personal information terminal 2 and that also cannot be altered by the user.

To exchange these sets of information, the device-end transmission/reception section 11 converts signal patterns for the information so that the device control section 12 can analyze the information received from the personal information terminal 2 and also that the information from the device control section 12 can be transmitted to the personal information terminal 2.

The device control section 12 performs predetermined computation to control the device-end transmission/reception section 11, the device memory 13, the tuner section 14, and other various functions of the video recorder 1 and is built around, for example, a CPU. Specifically, the device control section 12 schedules a recording of a program and plays back a program as instructed by the user of the personal information terminal 2 which communicates with the video recorder 1, and controls the display device 3 to display a program, an EPG, the progress of processing, etc. The device control section 12 also associates the terminal ID by which to identify the personal information terminal 2 with the recording schedule information specified in the personal information terminal 2 to provide information needed by the user of the personal information terminal 2.

The device control section 12 includes an ID reception determining section (reception determining means) 121 and a device information management section (setup means, device management means) 122 to do the control.

The ID reception determining section 121 determines whether or not the device-end transmission/reception section 11 has received recording schedule information or recording schedule command information. Specifically, the ID determining section 121 determines whether or not the device control section 12 has received a terminal ID together with the recording schedule information or the recording schedule command information received from the personal information terminal 2. If the ID reception determining section 121 determines that the device control section 12 has received a terminal ID, the section 121 transmits the terminal ID and either the recording schedule information or the recording schedule command information to the device information management section 122 to notify of the reception of the terminal ID. Meanwhile, if the ID reception determining section 121 determines that the device control section 12 has not received a terminal ID, the section 121 transmits the device information management section 122 a result of the determination that no terminal ID has been received.

The device information management section 122 manages, for example, information for transmission to/reception from the personal information terminal 2, information stored in the device memory 13, and information to be transmitted to the display device 3. The device information management section 122 determines from, for example, the result of the determination made in the ID reception determining section 121 whether to set up (specify) a terminal ID for the recording schedule information received. If no terminal ID has been set, the section 122 sets an unused terminal ID for the recording schedule information in reference to the device memory 13. The device information management section 122 also generates display screen data based on which the display device 3 displays, for example, a scheduled program list, a message that a scheduled recording is complete, and a list of recorded programs.

In other words, the device information management section 122 sets up a terminal ID by which to identify the personal information terminal 2 for the recording schedule information either received by the device-end transmission/reception section 11 or determined from the recording schedule command information received by the device-end transmission/reception section 11. The device information management section 122 manages the terminal ID and the recording schedule information in association with each other so that for each terminal ID, the display device 3 connected to the video recorder 1 can display the recording schedule information.

Upon receiving a command for a transmission of the device ID that is unique to the video recorder 1, (hereinafter, an “enquiry message”) from the personal information terminal 2, the device information management section 122 transmits the device ID to the personal information terminal 2. In other words, upon receiving from the personal information terminal 2 an enquiry message by means of which is requested a transmission of the device ID which is unique information representing the video recorder 1, the device information management section 122 transmits the device ID to the personal information terminal 2.

Furthermore, when the device-end transmission/reception section 11 has received the terminal-specific information that is unique to the personal information terminal 2 and cannot be altered by the user, the device information management section 122 manages the terminal-specific information as the terminal ID in association with the recording schedule information.

When the device-end transmission/reception section 11 has received, as additional information to the terminal ID, the personal ID that is information related to the user of the personal information terminal 2, the device information management section 122 manages the personal ID and the recording schedule information in association with each other so that for each personal ID, the display device 3 can display the recording schedule information.

The device memory 13 stores, for example, various data used in the device control section 12 and data obtained through execution of computer programs and is built around a volatile memory, such as a RAM (Random Access Memory), a non-volatile memory, such as a ROM (Read-Only Memory) or a flash memory, or a magnetic storage disk or an optical disc, such as a HDD. The device memory 13 stores, for example, a scheduled program table as the various data or computer programs. In other words, the device memory 13 stores, for example, the recording schedule information, the terminal ID, the personal ID, the device ID, and recorded program information.

Being connected to the antenna device 4, the tuner section 14 receives broadcasts, such as terrestrial analog/digital broadcasting, BS broadcasting, and CS broadcasting, via the antenna device 4 and converts signals so that the device control section 12 can process the broadcasts. The tuner section 14 receives an EPG or like computer program data. The video recorder 1 according to the present embodiment includes the tuner section 14 therein; alternatively, the recorder 1 may include the tuner section 14 as a peripheral, such as an extension card.

The video recorder 1 stores recording schedule software for installation in the personal information terminal 2. The recording schedule software generates the recording schedule information which enables scheduling of recordings in the video recorder 1 by using an EPG, iEPG, G code, etc. and is extension software executable on the personal information terminal 2 (e.g. JAVA® applications embedded or preinstalled in the personal information terminal 2). The video recorder 1 transmits the recording schedule software to the personal information terminal 2 by infrared communications via the device-end transmission/reception section 11. Alternatively, the recording schedule software may be transmitted from the video recorder 1 to the personal information terminal 2 so that the software does not need to be embedded or preinstalled in the personal information terminal 2. In other words, the software may not be embedded or preinstalled in the personal information terminal 2 if recording schedule software compatible with the video recorder 1 is installed using, for example, the Internet and flash memory.

Alternatively, the recording schedule software may not be software for generating the recording schedule information in the personal information terminal 2, but software, for example, enabling manipulation of an EPG displayed on the display device 3 connected to the video recorder 1. When that is the case, the personal information terminal 2 transmits the recording schedule command information enabling selection a program in the EPG to the video recorder 1.

The recording schedule software stored on the video recorder 1 is updated, for example, using digital data broadcast, the Internet, an optical disc, or flash memory.

### Brief Description of Configuration of Personal Information Terminal

Next, the configuration of the personal information terminal 2 which communicates with the video recorder 1 will be schematically described in reference to FIG. 1. As illustrated in FIG. 1, the personal information terminal 2 includes a terminal-end transmission/reception section (terminal-end reception means) 21, a terminal control section 22, a terminal memory 23, and an input section (input means) 24.

The terminal-end transmission/reception section 21 is provided for communications with the video recorder 1 and transmits/receives information, for example, the recording schedule information, the recording schedule command information, the terminal ID, and the personal ID. To exchange these sets of information, the terminal-end transmission/reception section 21 converts signal patterns for the information so that the terminal control section 22 can analyze the information received from the video recorder 1 and also that the information from the terminal control section 22 can be transmitted to the video recorder 1. The especially important role of the terminal-end transmission/reception section 21 is to receive the terminal ID, set up by the video recorder 1, by which the video recorder 1 identifies the personal information terminal 2. The terminal-end transmission/reception section 21 also transmits an enquiry message by means of which is requested a transmission of the device ID which is unique information representing the video recorder 1.

The terminal control section 22 performs predetermined computation to control the terminal-end transmission/reception section 21, the terminal memory 23, the input section 24, the display section 25, and other various functions of the personal information terminal 2 and is built around, for example, a CPU. Specifically, the terminal control section 22 issues commands to schedule a recording of a program and play back a program as instructed by the user of the personal information terminal 2 which communicates with the video recorder 1, and controls the display section 25 to display an iEPG, the progress of processing, etc.

The terminal control section 22 includes a terminal information management section (terminal management means) 221 to do the control. The terminal information management section 221 manages, for example, information for transmission to/reception from the video recorder 1, information stored in the terminal memory 23, and information received from the input section 24, and information to be transmitted to the display section 25. When the recording schedule information or the recording schedule command information from, for example, the input section 24 is stored in the terminal memory 23, the terminal information management section 221 transmits the terminal ID to the video recorder 1. In other words, the terminal information management section 221 manages the terminal ID received by the terminal-end transmission/reception section 21 so that the terminal ID can be transmitted to the video recorder 1 together with the recording schedule information or the recording schedule command information received by the input section 24.

The terminal information management section 221 sends an enquiry message to have the video recorder 1 transmit the device ID, and upon receiving the device ID, determines whether or not a terminal ID is set up which corresponds to the device ID. In other words, the terminal information management section 221 transmits at least the recording schedule information or the recording schedule command information to the video recorder 1 which transmitted the device ID in response to the enquiry message transmitted by the terminal-end transmission/reception section 21.

Furthermore, when the terminal information management section 221 has the terminal-specific information that is unique to the personal information terminal 2 and cannot be altered by the user, the section 221 manages so that the terminal-specific information can be transmitted to the video recorder 1.

When the input section 24 has received the personal ID that is information related to the user of the personal information terminal 2, the terminal information management section 221 manages the personal ID so that the personal ID can be linked to the terminal ID and transmitted to the video recorder 1.

The terminal memory 23 stores, for example, various data used in the terminal control section 22 and data obtained through execution of computer programs and is built around a volatile memory, such as a RAM (Random Access Memory), or a non-volatile memory, such as a ROM (Read-Only Memory) or a flash memory. The terminal memory 23 stores, for example, the recording schedule information, the terminal ID, and the device ID as the various data or computer programs.

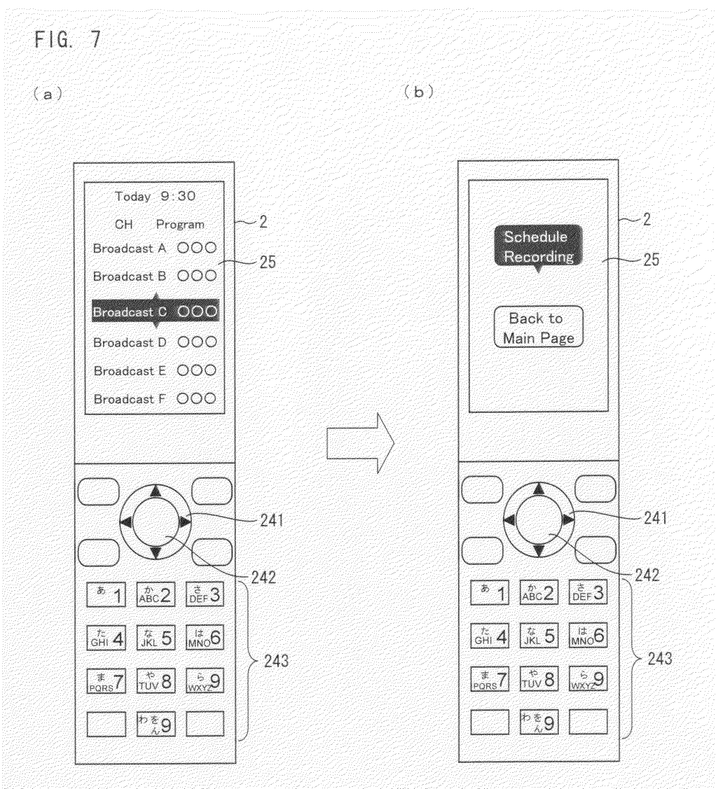

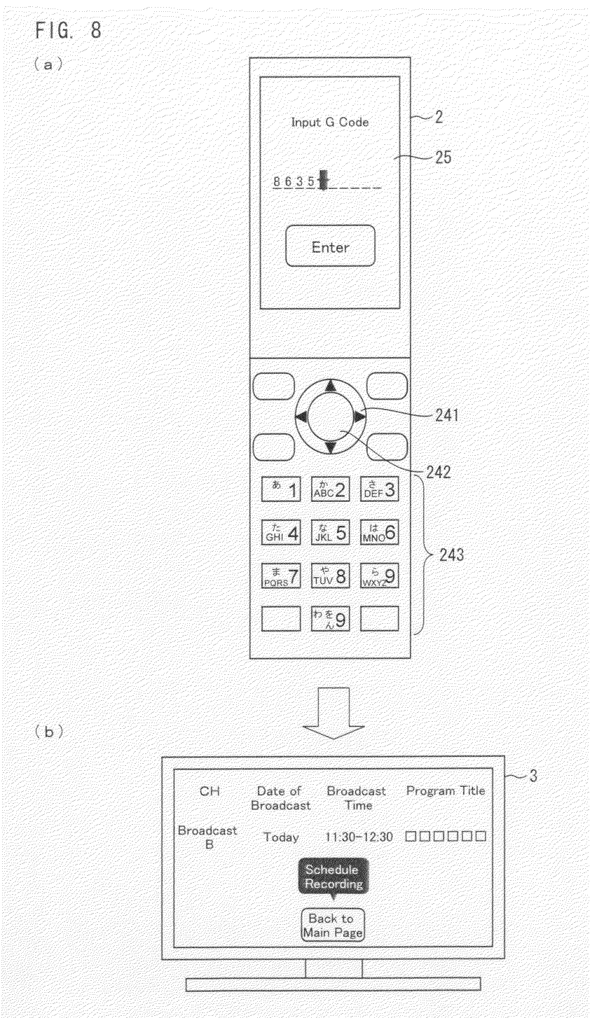

The input section 24 receives inputs from the user and includes, for example, a navigation key 241, an enter key 242, and a numeric keypad 243 shown in FIGS. 7 and 8. The user manipulates these buttons, looking at the screen displayed on the display device 3 or the display section 25, so that the video recorder 1 can operate as he/she wants (to schedule a recording, play back a program, etc.). In other words, the input section 24 receives the recording schedule command information including the recording schedule information or a command to determine the recording schedule information through inputs from the user for transmission to the video recorder 1.

### Video Recording in Information Communications System

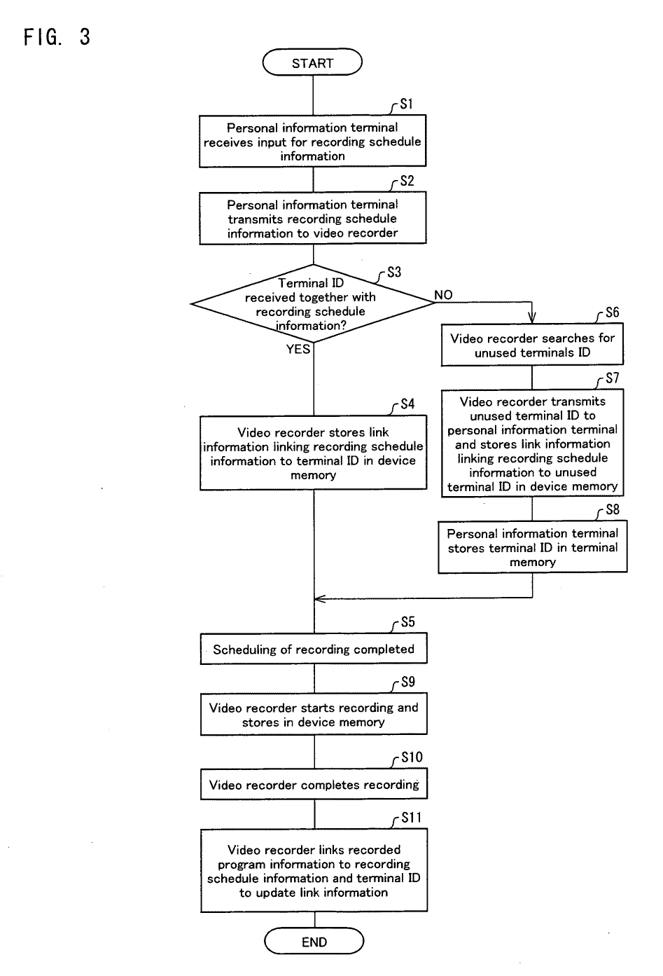

Next will be described a video recording process implemented by the video recorder 1 and the personal information terminal 2 in the information communications system 10. FIG. 3 is a flow chart depicting, as an example, a video recording process implemented by the video recorder 1 and the personal information terminal 2 in the information communications system 10.

First, the personal information terminal 2 receives inputs for the recording schedule information (S1). Specifically, upon receiving program information for the program of which the user wants to make a recording on the video recorder 1, the input section 24 in the personal information terminal 2 transmits the program information to the terminal control section 22. As the terminal control section 22 receives the program information, the terminal information management section 221 stores the program information as the recording schedule information in the terminal memory 23.

Next, the personal information terminal 2 transmits the recording schedule information to the video recorder 1 (S2). Specifically, the terminal information management section 221, upon storing the recording schedule information in the terminal memory 23, transmits the recording schedule information to the video recorder 1 via the terminal-end transmission/reception section 21. In so doing, the terminal information management section 221 accesses the terminal memory 23, and if there is already a terminal ID stored in the terminal memory 23, transmits the terminal ID to the video recorder 1 together with the recording schedule information. The terminal information management section 221 may transmit the terminal ID by including it in the recording schedule information transmitted to the video recorder 1.

Upon receiving the recording schedule information from the personal information terminal 2, the video recorder 1 determines whether or not a terminal ID has been received together with the recording schedule information (S3). Specifically, the device control section 12 in the video recorder 1 receives the recording schedule information from the personal information terminal 2 via the device-end transmission/reception section 11. If the personal information terminal 2 transmitted the terminal ID together with the recording schedule information, the device control section 12 receives the terminal ID together with the recording schedule information. In other words, the ID reception determining section 121 in the device control section 12 determines whether or not it has received the terminal ID together with the recording schedule information received by the device-end transmission/reception section 11.

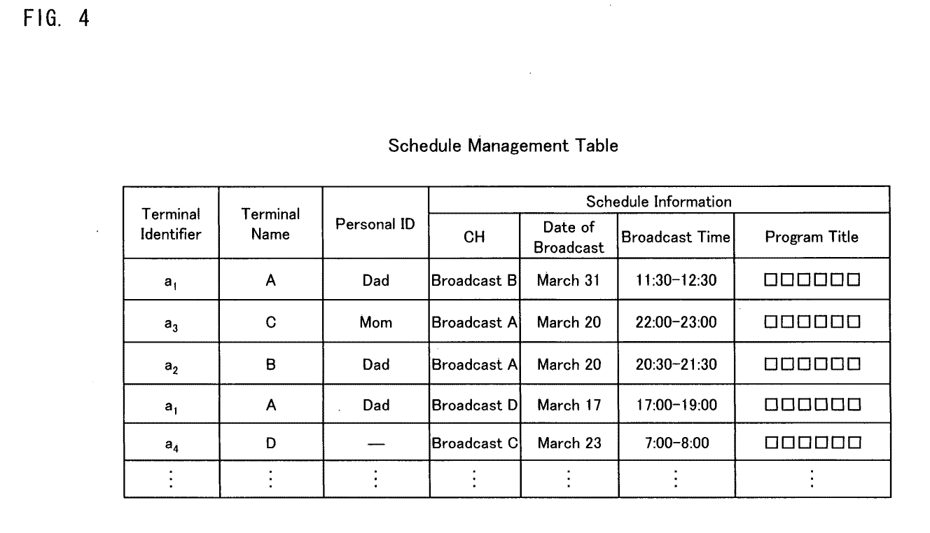

If it is determined that the terminal ID has been received together with the recording schedule information (YES in S3), the ID reception determining section 121 transmits these two sets of information to the device information management section 122. If these two sets of information have been received, the device information management section 122 determines that the ID reception determining section 121 has determined that the device control section 12 received the two sets of information. Then, the video recorder 1 stores link information linking the recording schedule information to the terminal ID in the device memory 13 (S4). Specifically, the device information management section 122 generates the link information by associating (linking) the recording schedule information received from the ID reception determining section 121 with the terminal ID, and stores the link information, for example, in the schedule management table in the device memory 13 shown in FIG. 4.

Now, the schedule management table shown in FIG. 4 is be described. The schedule management table illustrates an example of a storage format for the link information stored in the device memory 13. The schedule management table stores “Terminal Identifier” representing the terminal IDs, “Terminal Name” corresponding to the terminal IDs, and “Schedule Information” in association with each other as illustrated in FIG. 4. Note that FIG. 4 is a drawing showing a schedule management table which illustrates an example of a storage format for the link information stored in the device memory 13.

In other words, the schedule management table stores, in association with each other, “Terminal Identifier” representing terminal IDs specified for personal information terminals 2 from which recording schedule information was received, “Terminal Name” representing terminal names specified for the personal information terminals 2, and “Schedule Information” representing the recording schedule information received from the personal information terminals 2. Under “Schedule Information,” the schedule management table shown in FIG. 4 stores the recording schedule information representing information on the programs of which the users want to make recordings on the video recorder 1 and stores, in association with each other, “CH” representing broadcast channels, “Date of Broadcast” representing the planned dates of broadcasts, “Broadcast Time” representing planned time of the broadcasts, and “Program Title” representing program titles.

Suppose that the video recorder 1 has received, from a personal information terminal 2, recording schedule information representing that, for example, the broadcast channel (CH) is “Broadcast D,” the date of broadcast is “March 17,” the broadcast time is “17:00 to 19:00,” and a program title. Also assume that the video recorder 1 has received a terminal ID “a1” together with the recording schedule information. If the device information management section 122 has determined, by accessing the device memory 13, that the terminal ID a1 was set up before receiving the recording schedule information, the section 122 links the terminal ID a1 to the recording schedule information and generates link information. Then, the device information management section 122 stores the link information in the schedule management table in the device memory 13. The device information management section 122 sets up a terminal name (for example, “A”) in association with the link information upon generating the link information.

The schedule management table shown in FIG. 4 may further associate “Personal ID” (which will be detailed later) included in the link information.

Next, as the link information is stored in the device memory 13, the video recorder 1 determines that scheduling of a recording is complete (S5). Specifically, as the link information associating the recording schedule information and the terminal ID, both received from the personal information terminal 2, is stored in the device memory 13 in S2, the device information management section 122 determines that scheduling of a recording is complete. In so doing, the device information management section 122 transmits to the display device 3 a record scheduling complete message indicating that scheduling of a recording is complete and has the display device 3 display a scheduled program list corresponding to the terminal ID. Alternatively, the device information management section 122 may transmit the record scheduling complete message to the personal information terminal 2. In that case, the terminal control section 22 in the personal information terminal 2 may, upon receiving the record scheduling complete message, have the display section 25 display a text describing that scheduling of a recording is complete (or the scheduled program list).

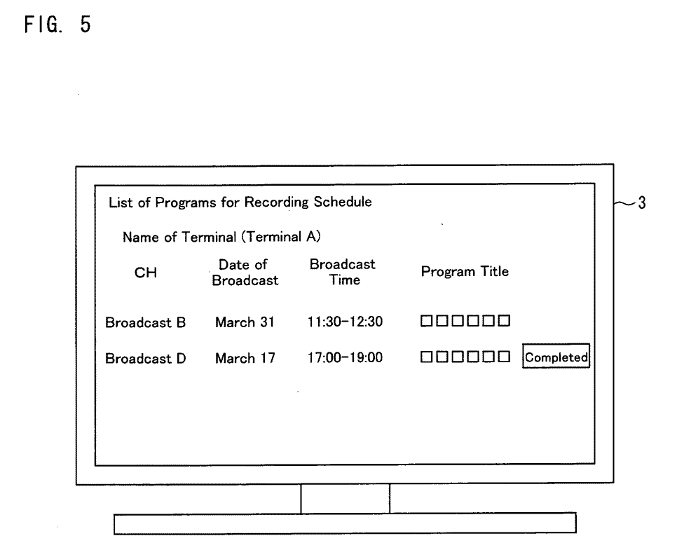

A display screen example for the display device 3 when the device information management section 122 has determined that the scheduling of a recording is complete will be described in reference to FIG. 5. FIG. 5 is an illustration of an example of a scheduled program list being displayed on the display device 3.

The device information management section 122, upon determining that the scheduling of a recording is complete, retrieves screen data representing a format for the scheduled program list displayed on the display device 3. The device information management section 122 also accesses the schedule management table in the device memory 13 to select a terminal identifier that is identical to the terminal identifier represented by the terminal ID stored in association with the recording schedule information received from the personal information terminal 2 in S2. Then, the device information management section 122 extracts all the recording schedule information associated with the same terminal identifier.

For example, if the video recorder 1 has received or set up the terminal ID a1, the device information management section 122 extracts the recording schedule information associated with the terminal identifier a1 stored in the device memory 13. Specifically, two sets of link information representing the terminal identifier a1 are stored in the schedule management table shown in FIG. 4. Therefore, the device information management section 122 extracts the two sets of recording schedule information associated with the terminal identifier a1. Then, the device information management section 122 generates, from the screen data representing a format for the scheduled program list and the recording schedule information, screen data representing the scheduled program list to be transmitted to the display device 3 so that these two sets of recording schedule information can be inserted at predetermined positions in the scheduled program list displayed on the display device 3. Upon receiving the screen data representing the scheduled program list from the video recorder 1, the display device 3 displays the scheduled program list shown in FIG. 5. In other words, the video recorder 1 can have the display device 3 display a scheduled program list representing only the recording schedule information from the personal information terminal 2 from which the recording schedule information was received in S2.

The terminal name (for example, “Terminal A”) associated with the terminal ID in the schedule management table shown in FIG. 4 may not be displayed in the scheduled program list displayed on the display device 3. In addition, a mark “Scheduling Completed” may also be displayed, for example, to the right of the program title in the scheduled program list as illustrated in FIG. 5. This is achieved by, for example, configuring the device information management section 122 so that a mark “Scheduling Completed” is set up at a predetermined position in the screen data representing a format for the scheduled program list when the link information is updated in S11 (detailed later).

Meanwhile, if the ID reception determining section 121 has determined that no terminal ID was received together with the recording schedule information (NO in S3), the video recorder 1 searches for unused terminals ID (S6). Specifically, the ID reception determining section 121 transmits to the device information management section 122 the result of the determination that no terminal ID was received together with the recording schedule information. The device information management section 122, upon receiving the result of the determination from the ID reception determining section 121, starts searching for terminal identifiers that are not used in the schedule management table. Then, the device information management section 122 extracts one of unused terminal identifiers as an unused terminal ID by searching for terminal identifiers that are not used in the schedule management table. In other words, upon receiving the result of the determination, the device information management section 122 searches for unused terminal IDs and extracts one of them to set up a terminal ID for the personal information terminal 2 from which the recording schedule information was received in S2. There are, for example, n terminal identifiers a1 to an stored as terminal IDs on the device memory 13.

For example, terminal identifiers a1 to a4 are used in the schedule management table shown in FIG. 4. Therefore, in this case, the device information management section 122 extracts one of the terminal identifiers a5 to an that are not used in the schedule management table (for example, a terminal identifier a5) as an unused terminal ID. Assuming that the video recorder 1 is used at home, the number of the terminal identifiers stored in the device memory 13 may be set to a value sufficiently cover the total number of the personal information terminals 2 owned by family members; alternatively, the number may be set according to the situation in which the video recorder 1 is used. Each terminal identifier in the foregoing example (a1 to an) is a code made up of a combination of a number and an English letter; alternatively, the terminal identifier may be a code made up, for example, a single number or a single letter so long as the video recorder 1 can identify the personal information terminal 2 with the code.

As the device information management section 122 has set up a terminal ID by searching for unused terminal IDs and extracting one of them, the video recorder 1 transmits the terminal ID to the personal information terminal 2 and stores the link information linking the recording schedule information and the terminal ID in the device memory 13 (S7). Specifically, the device information management section 122 first transmits the unused terminal ID extracted from the device memory 13 to the personal information terminal 2 via the device-end transmission/reception section 11. Then, the terminal information management section 221 in the personal information terminal 2 receives the terminal ID via the terminal-end transmission/reception section 21 and stores the terminal ID to the terminal memory 23. In other words, the personal information terminal 2 stores the terminal ID received from the video recorder 1 to the terminal memory 23 (S8). In so doing, the device information management section 122 generates the link information by mutually associating (linking) the recording schedule information received from the ID reception determining section 121 and the unused terminal ID extracted (set up), and stores the link information in the schedule management table in the device memory 13. Then, upon completion of S7 and S8, the process continues to S5 carried out in the video recorder 1.

At the broadcast start time indicated by the recording schedule information stored in the device memory 13, the device information management section 122 in the video recorder 1 starts recording the program indicated by the recording schedule information to store the program in the device memory 13 together with the recorded program information associated (linked) with the program (S9). Then, the device information management section 122 in the video recorder 1 terminates the recording of the program indicated by the recording schedule information at the broadcast end time indicated by the recording schedule information (S10).

In other words, the device information management section 122 has the recording of the program started and terminated respectively at the start time and the end time of the program indicated by the recording schedule information stored in the device memory 13, and stores the recorded program (recorded content) in the device memory 13 together with the recorded program information. The recorded program information refers to information including the title of a program, the time of a broadcast, a channel, and the synopsis of a program.

The device information management section 122 in the video recorder 1, upon having the recording of the program terminated, updates the link information stored in device memory 13 in S4 or S7 by linking the recorded program information linked to the recorded program to the recording schedule information and the terminal ID stored in the device memory 13 (S11). In other words, the device information management section 122 adds the recorded program information to the link information stored in the device memory 13 in S4 or S7 to update the link information. Then, the device information management section 122 stores the updated link information in the schedule management table in the device memory 13.

From the above description, in the video recorder 1, the ID reception determining section 121 determines whether or not the section 121 received the terminal ID when the section 121 received the recording schedule information from the personal information terminal 2. If the ID reception determining section 121 has determined that the section 121 received the terminal ID, the device information management section 122 stores the recording schedule information and the terminal ID, both received from the personal information terminal 2, in association with each other in the device memory 13. In contrast, if the ID reception determining section 121 has determined that the section 121 did not receive a terminal ID, the device information management section 122 sets up a terminal ID for the personal information terminal 2 and stores the terminal ID and the recording schedule information in association with each other in the device memory 13. Then, the device information management section 122 generates a scheduled program list from these associated sets of information so that the display device 3 can display the scheduled program list.

Accordingly, the video recorder 1 can have the display device 3 display only the recording schedule information for the program of which the user has scheduled a recording, without having to have information on either the user who schedules the recording of the program or the personal information terminal 2 used by the user obtained through inputs from the user on the personal information terminal 2. In other words, the video recorder 1 does not need to have the user who schedules the recording of the program using the information terminal perform any manipulation other than entering program recording commands; hence, the video recorder 1 can readily have the user recognize only the recording schedule information that he/she needs.

Meanwhile, the personal information terminal 2 can have the display device 3 display only the schedule information for the program of which the user has scheduled a recording, without having to obtain information on either the user who schedules the recording of the program or the information terminal used by the user through inputs from the user and transmitting the information to the video recorder 1.

### Video Recording in Information Communications System (for Video Recorder Receiving Recording Schedule Command Information)

The user of the personal information terminal 2 may schedule a recording of a program he/she wants while viewing the EPG displayed on the display device 3 connected to the video recorder 1. A process in that case will be described in reference to the flow chart shown in FIG. 3. The same steps as those described in relation to the video recording process in the information communications system will not be again described here.

In S1, the personal information terminal 2 receives inputs of recording schedule command information including commands by which to determine recording schedule information. Specifically, the input section 24 in the personal information terminal 2 receives commands by which to select a program of which the user wants to make a recording in the video recorder 1 from the program section of an EPG being displayed on the display device 3. In other words, every time the input section 24 receives an input made through the navigation key 241 or the enter key 242, the input section 24 receives and transmits the input as recording schedule command information to the terminal information management section 221.

In S2, every time the terminal information management section 221 receives the recording schedule command information from the input section 24, the section 221 transmits to the video recorder 1 via the terminal-end transmission/reception section 21. In other words, the terminal information management section 221 transmits the recording schedule command information, in place of the recording schedule information, to the video recorder 1. The recording schedule command information represents command signals for moving the cursor (highlighting of various buttons displayed on the display device 3) operated on the EPG displayed on the display device 3 and command signals for selecting one of programs (program buttons), record scheduling buttons, a return button, etc. displayed on the display device 3 and entering a command.

Next, if in S3, the device control section 12 received the terminal ID when the section 12 received the first recording schedule command information of the recording schedule command information transmitted from the personal information terminal 2, the ID reception determining section 121 determines that the section 121 received the terminal ID together with the recording schedule command information. After S3, the process continues to S4 or S6.

While the device control section 12 is receiving the recording schedule command information via the device-end transmission/reception section 11 (every time the section 12 receives the recording schedule command information), the device information management section 122 performs a process corresponding to the recording schedule command information. For example, if the recording schedule command information indicates a command for a motion of the cursor, the device information management section 122 calculates a cursor motion quantity and moves the cursor displayed on the display device 3 in position on the basis of the cursor motion quantity. In so doing, the device information management section 122 generates display screen data representing an EPG screen in accordance with the motion of the cursor and transmits the data to the display device 3. Then, the display device 3 displays on the basis of the display screen data received from the video recorder 1.

If the recording schedule command information indicates selecting of one of the various buttons displayed on the display device 3 and entering of a command, the device information management section 122 retrieves screen data corresponding to the selected functions from the device memory 13. For example, if a program is selected on the EPG displayed on the display device 3, the device information management section 122 retrieves from the device memory 13, for example, text data representing the content of the selected program and screen data for the display device 3 to display the record scheduling buttons and the return button.

That is, if the video recorder 1 has received recording schedule command information from the personal information terminal 2, the device control section 12 determines whether or not recording schedule information has been received from the personal information terminal 2, by determining whether or not one of the record scheduling buttons, displayed on the display device 3 in S3, for confirming the scheduling of a recording has been selected.

Specifically, if the device control section 12 has received recording schedule command information indicating selecting of one of the record scheduling buttons and entering of a command, the device information management section 122 determines that one of the record scheduling buttons has been selected and retrieves screen data representing completion of a scheduling of a recording from the device memory 13 for a transmission to the display device 3. In so doing, the device information management section 122 stores the program information selected (determined) according to the recording schedule command information (for example, the text data representing the program content retrieved from the device memory 13) as the recording schedule information in the device memory 13. In storing the recording schedule information in the device memory 13, the device information management section 122 generates link information by mutually associating (linking) the recording schedule information and the terminal ID (or unused terminal ID set up in S6) similarly to S4 or S7. Then, the device information management section 122 stores the link information, for example, in the schedule management table shown in FIG. 4.

In S7, the device information management section 122 transmits the recording schedule information stored in the device memory 13 together with the specified unused terminal ID to the personal information terminal 2 via the device-end transmission/reception section 11. Then, in S8, the terminal information management section 221 in the personal information terminal 2 receives the recording schedule information together with the terminal ID via the terminal-end transmission/reception section 21 and stores the received terminal ID and recording schedule information in the terminal memory 23.

From the above description, when the video recorder 1 is having the display device 3 display an EPG, the user can transmit recording schedule command information for manipulation of the EPG to the video recorder 1 by using the personal information terminal 2. In other words, the video recorder 1 enables the user to schedule a recording using the personal information terminal 2 even if the personal information terminal 2 does not generate recording schedule information.

### Video Recording in Information Communications System (for Video Recorder Receiving Personal ID)

The user of the personal information terminal 2 may input the personal ID on the input section 24. The personal ID is information (supplementary information to the terminal ID) on the user of the personal information terminal 2: for example, the name or nickname of the user (e.g., Dad or Mom), text data, graphic data for a male or female face icon. The personal ID is not necessarily information representing only the user who makes inputs on the input section 24 and may be any desirable information to the user: for example, “Dad//Mom” in which case the ID is data identifying a plurality of users.

In this case, in S1, the input section 24 in the personal information terminal 2 obtains the personal ID and links the personal ID to the terminal ID for a transmission to the terminal information management section 221. In S2, the terminal information management section 221 transmits the terminal ID linked to the personal ID to the video recorder 1 together with the recording schedule information or the recording schedule command information. The personal information terminal 2 transmits the personal ID by linking the personal ID to the terminal ID; alternatively, the terminal 2 may only transmit the personal ID.

As the device control section 12 in the video recorder 1 receives the terminal ID to which the personal ID is linked, the device information management section 122 generates link information by associating (linking) to the received recording schedule information or the recording schedule information generated based on the recording schedule command information. Then, the device information management section 122 stores the link information in the schedule management table shown in FIG. 4 in the device memory 13.

For example, the schedule management table shown in FIG. 4 stores the same personal ID “Dad” in association with the terminal IDs showing the terminal identifiers a1 and a2. In other words, the same personal ID is associated with the recording schedule information transmitted from different personal information terminals 2. In the schedule management table, the personal ID “−” shows that the video recorder 1 has not received a personal ID (that is, received only a terminal ID).

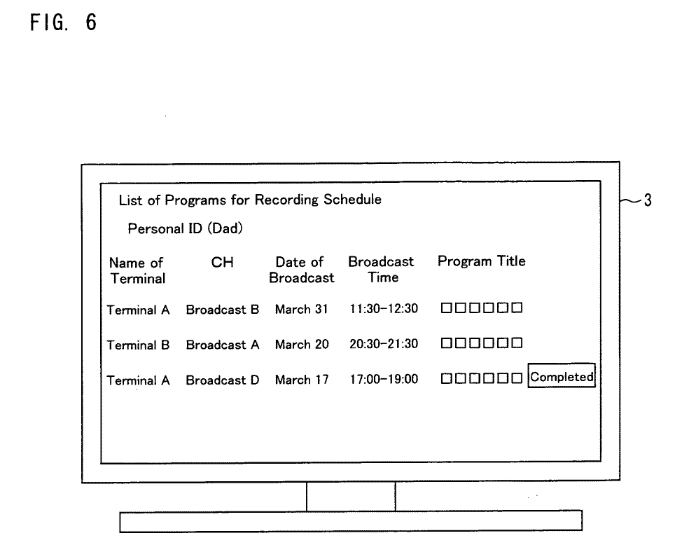

Now, an example of the display screen on the display device 3 when the video recorder 1 has received a personal ID will be described in reference to FIG. 6. FIG. 6 is an illustration of another example of a scheduled program list displayed on the display device 3.

The device information management section 122, upon determining that the scheduling of a recording is complete, retrieves screen data representing a format for the scheduled program list displayed on the display device 3. The device information management section 122 also accesses the schedule management table in the device memory 13 to select an identical personal ID to the personal ID received in S2 from the personal information terminal 2. Then, the device information management section 122 extracts all the recording schedule information associated with the same personal ID.

For example, if the video recorder 1 has received a personal ID “Dad,” the device information management section 122 extracts the recording schedule information associated with the personal ID “Dad” stored in the device memory 13. Specifically, three sets of link information representing the personal ID “Dad” are stored in the schedule management table shown in FIG. 4. Therefore, the device information management section 122 extracts the three sets of recording schedule information associated with the personal ID “Dad.” Then, the device information management section 122 generates, from the screen data representing a format for the scheduled program list and the recording schedule information, screen data representing the scheduled program list to be transmitted to the display device 3 so that these three sets of recording schedule information can be inserted at predetermined positions in the scheduled program list displayed on the display device 3. Upon receiving the screen data representing the scheduled program list from the video recorder 1, the display device 3 displays the scheduled program list shown in FIG. 6. In other words, the video recorder 1 has the display device 3 display a scheduled program list representing only the recording schedule information from the personal information terminal 2 to which the personal ID was sent in S2.

The personal ID and the terminal names (for example, “Terminal A,” and “Terminal B”) associated with the personal ID may not be displayed in the scheduled program list displayed on the display device 3. In addition, the device information management section 122 may also control, similarly to the scheduled program list in FIG. 5, so that a mark “Scheduling Completed” can be displayed to the right of the program title in the scheduled program list as illustrated in FIG. 6.

A description is now given taking as an example the information communications system 10 shown in FIG. 2(b). In the information communications system 10 shown in FIG. 2(b), the video recorder 1 corresponds to Video Recorder A, the two personal information terminals 2 correspond to Personal Information Terminal A and Personal Information Terminal B. Suppose also that Personal Information Terminals A and B are used by a single user.

As illustrated in FIG. 2(b), Personal Information Terminals A and B each transmit a terminal ID to which the personal ID “Dad” is linked together with the recording schedule information or the recording schedule command information. As Video Recorder A receives these sets of information, the device information management section 122 stores the received terminal ID to which the personal ID is linked in the device memory 13 in association with the recording schedule information (or recording schedule information based on the recording schedule command information). Upon determining that these sets of information have been stored in the device memory 13 and the scheduling of the recording is complete, the device information management section 122 has the display device 3 display, for example, a screen shown in FIG. 6.

From the above description, in a configuration where the personal information terminal 2 obtains a personal ID, the device information management section 122 in the video recorder 1 inserts even link information containing recording schedule information set up by different personal information terminals in the same scheduled program list displayed on the display device 3 if the personal IDs are identical. Therefore, when the user is using a plurality of personal information terminals 2, the video recorder 1 can generate a scheduled program list in which the programs of which the user has scheduled a recording are shown, so that the display device 3 can display the list.

In other words, the video recorder 1 can have the display device 3 display the recording schedule information associated with the same personal ID even when, for example, the terminal IDs are different. Therefore, even when, for example, the user is using a plurality of personal information terminals 2 to set up scheduling recordings of programs, the user can easily recognize the programs of which he/she has scheduled a recording because the programs are displayed on the display device 3.

### Video Recording in Information Communications System (Processing in Personal Information Terminal 2)

In S1 processing, the terminal information management section 221 in the personal information terminal 2 transmits the recording schedule information or the recording schedule command information obtained by the input section 24 to the video recorder 1. Now a case will be described in which a plurality of video recorders 1 perform a process to transmit respective device IDs before the terminal information management section 221 transmits the recording schedule information or the recording schedule command information to the video recorder 1.

Specifically, the input section 24, upon obtaining the program information or the recording schedule command information, transmits these sets of information to the terminal control section 22. The terminal information management section 221 in the terminal control section 22, upon receiving these sets of information, sends an enquiry message to have the video recorders 1 transmit the device IDs.

In each video recorder 1, as the device control section 12 receives the enquiry message for the device ID via the device-end transmission/reception section 11, the device information management section 122 accesses the device memory 13, retrieves the device ID stored in the device memory 13, and transmits the device ID to the personal information terminal 2. The device ID refers to unique information representing each video recorder 1 such that the personal information terminal 2 can identify the plurality of video recorders 1. The device ID may be made up of, for example, numbers, English letters, or a combination of the numbers and letters.

In the personal information terminal 2, as the terminal control section 22 receives a device ID via the terminal-end transmission/reception section 21, the terminal information management section 221 retrieves the terminal ID stored in the terminal memory 23 to determine whether the terminal ID was set up in association with the device ID. Suppose that each video recorder 1 transmitted its device ID by linking it to the terminal ID for a transmission to the personal information terminal 2.

The terminal information management section 221, upon having determined that the retrieved terminal ID was set up in association with the received device ID, transmits the terminal ID to the video recorder 1 from which the device ID was received, together with the recording schedule information or the recording schedule command information received from the input section 24. In contrast, upon having determined that the retrieved terminal ID was not set up in association with the received device ID, the terminal information management section 221 transmits only the recording schedule information or the recording schedule command information received from the input section 24 to the video recorder 1 from which the device ID was received. In other words, in this case, by the personal information terminal 2 transmitting only the recording schedule information or the recording schedule command information to the video recorder 1, the video recorder 1 sets up an unused terminal ID for the personal information terminal 2.

A description is now given taking as an example the information communications system 10 shown in FIG. 2(c). In the information communications system 10 shown in FIG. 2(c), the personal information terminal 2 corresponds to Personal Information Terminal A, the two video recorders 1 correspond to Video Recorder A and Video Recorder B.

As illustrated in FIG. 2(c), Personal Information Terminal A sends an enquiry message to Video Recorder A and Video Recorder B for a device ID. The device information management section 122 in each Video Recorders A and B accesses the device memory 13, retrieves the device ID stored in the device memory 13, and transmits the retrieved device ID to Personal Information Terminal A. Suppose in the information communications system 10 shown in FIG. 2(c) that Video Recorder A transmitted its terminal ID a1 to Personal Information Terminal A before receiving the enquiry message whereas Video Recorder B did not transmit its terminal ID to Personal Information Terminal A before receiving the enquiry message.

The terminal information management section 221 in Personal Information Terminal A, upon receiving a device ID from Video Recorder A, retrieves the terminal ID from the terminal memory 23 to determine whether the terminal ID was set up in association with the device ID. The terminal memory 23 in Personal Information Terminal A contains the terminal ID a1 set up by Video Recorder A. Therefore, the terminal information management section 221 determines that the retrieved terminal ID a1 was set up in associating with the device ID received from Video Recorder A. Then, the terminal information management section 221 transmits the retrieved terminal ID a1 to Video Recorder A together with the recording schedule information or the recording schedule command information.

Also, upon receiving a device ID from Video Recorder B, the terminal information management section 221 similarly retrieves the terminal ID from the terminal memory 23 and determines whether the terminal ID was set up in association with the device ID. The terminal memory 23 of Personal Information Terminal A does not contain the terminal ID set up by Video Recorder B. Therefore, the terminal information management section 221 determines that the retrieved terminal ID was not set up in association with the device ID received from Video Recorder B. Then, the terminal information management section 221 transmits only the recording schedule information or the recording schedule command information to Video Recorder B.

Upon receiving only the recording schedule information or the recording schedule command information from Personal Information Terminal A, Video Recorder B transmits an unused terminal ID (for example, terminal ID b1) stored in the device memory 13 to Personal Information Terminal A. There are n terminal IDs (terminal identifiers) b1 to bn stored in the device memory 13 in Video Recorder B.

The terminal information management section 221 may issue a command to request that Video Recorder B set up a terminal ID if it is determined that the retrieved terminal ID was not set up in associating with the device ID received from Video Recorder B. In that case, in Video Recorder B, as the device control section 12 receives the request from Personal Information Terminal A, the device information management section 122 transmits an unused terminal ID stored in the device memory 13 to Video Recorder B.

From the above description, the video recorder 1 transmits the device ID to the personal information terminal 2 upon receiving the enquiry message from the personal information terminal 2. Accordingly, the video recorder 1 can notify the personal information terminal 2 that the recorder 1 can communicate with the terminal 2. In other words, the personal information terminal 2 can recognize the video recorder(s) 1 with which the terminal 2 can communicate. Thus, the terminal 2 can transmit the recording schedule information or the recording schedule command information to, for example, a plurality of video recorders 1. Therefore, the user can send a command for recording scheduling to a plurality of communicable video recorders 1 by using the single personal information terminal 2.

The information communications system 10 shown in FIG. 2(c) includes two video recorders 1; this is not the only possibility. The system may include three or more video recorders 1. In addition, even if there is only one video recorder 1, the personal information terminal 2 may send an enquiry message to the video recorder 1 as above to have the video recorder 1 transmit the device ID. Accordingly, for example, if the user buys a new video recorder 1 in addition to the existing one, the personal information terminal 2 can schedule recordings for all the video recorders 1.

The video recorder 1 however does not need to transmit the device ID to the personal information terminal 2 when the personal information terminal 2 is allowed to schedule a recording only for one video recorder 1. Therefore, in that case, the personal information terminal 2 may be configured to receive an input indicating that the terminal 2 is allowed to schedule a recording only for one video recorder 1 when the recording schedule information or the recording schedule command information is input. In that case, the personal information terminal 2 is configured not to send an enquiry message to the video recorder 1 to have the video recorder 1 transmit the device ID.

### Video Recording in Information Communications System (Mobile Phone as Personal Information Terminal)

The personal information terminal 2 in the description above is configured to transmit the terminal ID set up in the video recorder 1 to the video recorder 1 together with the recording schedule information or the recording schedule command information. This is not only possibility. When the personal information terminal 2 is, for example, a mobile phone, the mobile phone has a mobile phone number (telephone number for the personal information terminal 2) that is given when the user starts using the mobile phone. In other words, the personal information terminal 2 has terminal-specific information (“mobile phone number”) unique to the terminal that cannot be overwritten by the user. Therefore, the personal information terminal 2 may be configured to transmit the mobile phone number, in place of the terminal ID set up in the video recorder 1, together with the recording schedule information or the recording schedule command information.

The following description will deal with a case where a mobile phone which has a mobile phone number as the personal information terminal 2 is used. This is not the only possibility. The description also applies to any personal information terminal 2 and electronic device that has terminal-specific information unique to the personal information terminal 2 that cannot be altered by the user.

If the mobile phone utilizes an SIM card, the personal information terminal 2 may be configured to transmit the mobile phone number recorded in the SIM card to the video recorder 1 as the terminal-specific information.

In other words, in some mobile phones, the mobile phone number is stored not in the main body of the mobile phone, but in an IC card, called an SIM (Subscriber Identity Module) card, which can be removed from the mobile phone. In this situation, a plurality of SIM card can be attached to the mobile phone. A plurality of mobile phone numbers may be in some cases used for one mobile phone, and one mobile phone number may be used for a plurality of mobile phones in other cases. In any of these cases, the personal information terminal 2 transmits the mobile phone number recorded in the attached SIM card as the terminal-specific information to the video recorder 1.

In that case, in S1, the personal information terminal 2 transmits the mobile phone number as the terminal ID to the video recorder 1. As the device control section 12 in the video recorder 1 receives the mobile phone number, the ID reception determining section 121 determines that the terminal ID has been received and transmits the mobile phone number and either the recording schedule information or the recording schedule command information to the device information management section 122. Then, the device information management section 122 stores the terminal ID (mobile phone number) and recording schedule information in the device memory 13.

Accordingly, by determining that the terminal ID is received when the terminal-specific information is received, the video recorder 1 can have the display device 3 display only the recording schedule information for the program of which the user has scheduled a recording, without having the information on the user who schedules the recording of the program or on the personal information terminal 2 being used by the user obtained by the user inputs on the personal information terminal 2.

By determining that the terminal ID is received when the terminal-specific information is received, the video recorder 1 can also set up the terminal ID for the personal information terminal 2 to manage the personal information terminal 2 and the recording schedule information in association with each other without transmitting the terminal ID. In other words, the video recorder 1 can omit the structure to set up a terminal ID and transmit the terminal ID to the personal information terminal 2, allowing for simplification of the configuration.

In contrast, even in transmitting the terminal-specific information to the video recorder 1, the personal information terminal 2 can have the display device 3 display only the recording schedule information for the program of which the user has scheduled a recording, without having the information on the user who schedules the recording of the program or on the personal information terminal 2 being used by the user obtained by the user inputs and transmitted to the video recorder 1.

The personal information terminal 2 transmits the terminal-specific information, in place of the terminal ID, to the video recorder 1; alternatively, the terminal 2 may transmit the terminal-specific identify to the video recorder 1 together with the terminal ID. In that case, the device information management section 122 in the video recorder 1 is configured to store the received terminal ID and terminal-specific information in association with each other in the device memory 13.

In addition, the personal information terminal 2 may also transmit the terminal ID to which the aforementioned personal ID is linked to the video recorder 1 when the terminal-specific information (mobile phone number) is transmitted to the video recorder 1. When that is the case, the video recorder 1 can have the display device 3 display only the name, the nickname, etc. by transmitting the personal ID to the display device 3. The personal information terminal 2 may transmit the terminal-specific information to which the personal ID is linked when the terminal-specific information is transmitted to the video recorder 1.

Furthermore, the device information management section 122 may be configured to, upon the device control section 12 in the video recorder 1 receiving the mobile phone number from the personal information terminal 2, encrypt the mobile phone number for storage in the device memory 13. In other words, the device information management section 122 encrypts and manages the terminal-specific information. In so doing, the encrypted mobile phone number (that is, a converted code generated by substitution and transposing for every numeric value or bit according to a predetermined algorithm so that it cannot be recognized as a telephone number) is stored as the terminal ID in the device memory 13.

In that case, the video recorder 1 encrypts the mobile phone number, which is personal information of highly confidential nature to the user using the mobile phone as the personal information terminal 2, before storing it. Therefore, when, for example, the user discards the video recorder 1, the configuration prevents leakage of the telephone number in advance.

### Scheduling of Recording

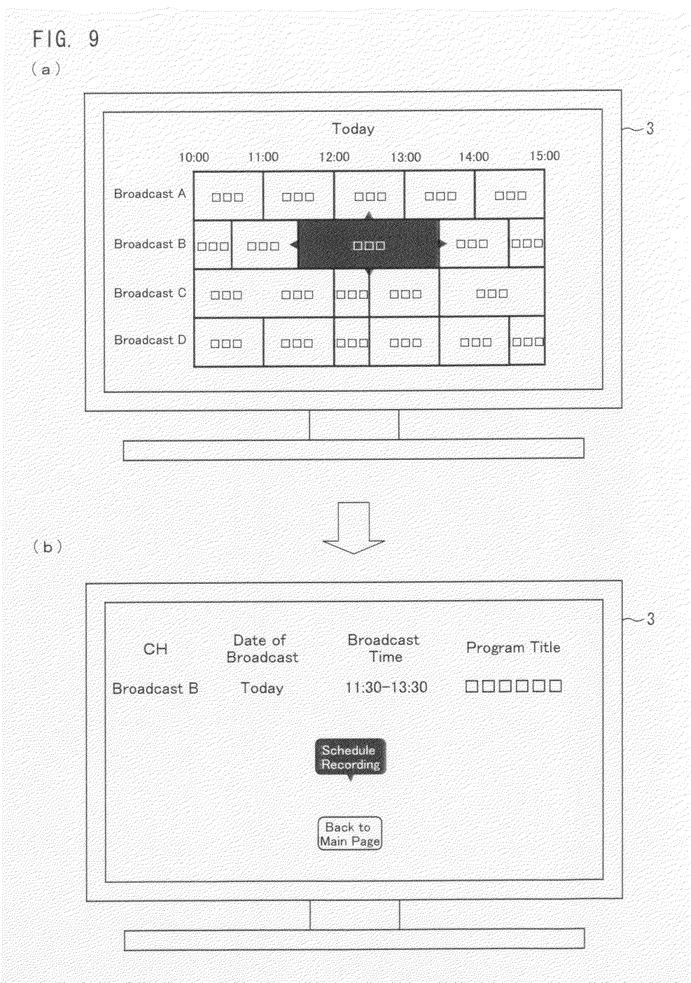

The processing in S1 in the personal information terminal 2 will be described in reference to FIGS. 7 to 9. FIG. 7 is an illustration of a change of a screen in setting up a scheduled recording using an iEPG displayed on the display section 25 in the personal information terminal 2. FIG. 8 is an illustration of a display screen on the display section 25 and a display screen on the display device 3 in setting up a scheduled recording via a G code input screen displayed on the display section 25 in the personal information terminal 2. FIG. 9 is an illustration of a change of a screen in setting up a scheduled recording using an EPG displayed on the display device 3 connected to the video recorder 1. FIGS. 7 to 9 show a mobile phone as the personal information terminal 2 (FIG. 9 showing manipulation using the mobile phone in FIGS. 7 and 8). However, as mentioned earlier, the personal information terminal 2 may be any PDA or like device that can communicate with the video recorder 1 and that enables scheduling of a recording.

First, the terminal information management section 221 in the personal information terminal 2 has the display section 25 display an EPG shown in (a) of FIG. 7 by storing in advance iEPG screen data downloaded, for example, over the Internet in the terminal memory 23 and retrieving the iEPG screen data from the terminal memory 23. Next, the input section 24 receives a command to select a program of which the user wants to make a recording in the video recorder 1 from the program section in the iEPG displayed on the display section 25. In other words, every time the input section 24 receives an input made through the navigation key 241 or the enter key 242, the input section 24 receives and transmits the input as recording schedule command information to the terminal information management section 221. The recording schedule command information represents command signals for moving the cursor (highlighting of various buttons displayed on the display section 25) operated on the iEPG displayed on the display section 25. The recording schedule command information also represents programs (program buttons) displayed on the display section 25 shown in (a) of FIG. 7 and command signals for selecting from the record scheduling buttons, return button, etc. shown in (b) of FIG. 7 and entering a command.

The terminal information management section 221, upon receiving recording schedule command information representing an input made through the navigation key 241, calculates a cursor motion quantity and moves the cursor displayed on the display section 25 in position on the basis of the cursor motion quantity. In so doing, the terminal information management section 221 generates display screen data representing an iEPG screen in accordance with the motion of the cursor with respect to iEPG screen data and has the display section 25 display a screen on the basis of the display screen data. Accordingly, the user can select a program of which the user wants to make a recording in the video recorder 1 by manipulating the navigation key 241.

Then, if the terminal information management section 221 receives recording schedule command information representing an input made through an enter key 242 while the screen shown in (a) of FIG. 7 is being displayed on the display section 25, the section 221 retrieves, from the terminal memory 23, screen data from which the display section 25 displays the screen shown in (b) of FIG. 7. In so doing, the terminal information management section 221 stores in the terminal memory 23 the program information highlighted when recording schedule command information representing an input made through the enter key 242 was received (program information corresponding to Broadcast C in the case of (a) of FIG. 7). Thereafter, the terminal information management section 221, upon receiving recording schedule command information representing an input made through the navigation key 241, performs the aforementioned cursor processing to move (switch) highlighting of the record scheduling buttons or return button. Then, the terminal information management section 221, upon receiving an input made through the enter key 242 on the screen shown in (b) of FIG. 7, retrieves the screen data corresponding to the functions set up for the record scheduling button and the return button from the terminal memory 23.

In other words, upon receiving an input made through the enter key 242 while one of the record scheduling buttons is being highlighted, the terminal information management section 221 determines the record scheduling button has been selected, retrieves the program information stored in the terminal memory 23 when the section 221 had the display section 25 display the screen shown in (b) of FIG. 7, and transmits the program information as recording schedule information to the video recorder 1. In contrast, upon receiving an input made through the enter key 242 while the return button is being highlighted, the terminal information management section 221 determines that the return button has been selected, retrieves the screen data representing the screen shown in (a) of FIG. 7 from the terminal memory 23, and has the again display section 25 display the screen shown in (a) of FIG. 7.

Accordingly, while having the display section 25 in the personal information terminal 2 display an iEPG, the user can schedule a recording of a desired program in the video recorder 1 by manipulating the input section 24 in the personal information terminal 2.

Next will be described setting up a scheduled recording on a G code input screen. The terminal information management section 221 in the personal information terminal 2 retrieves the screen data representing a G code input screen stored in the terminal memory 23 from the terminal memory 23 to have the display section 25 display the G code input screen shown in (a) of FIG. 8. The G code input screen shown in (a) of FIG. 8 includes, for example, a G code display area where a G code is displayed and a confirm button. In the case of, for example, a mobile phone, the G code input screen may be a numeric value input screen which is displayed where a numeric value is input.

The terminal information management section 221, upon receiving recording schedule command information representing an input made through the numeric keypad 243 on the input section 24, generates, as a G code input screen, display screen data in which numeric value data indicated by the recording schedule command information is inserted in the G code display area and has the display section 25 display a screen on the basis of the display screen data. The terminal information management section 221 stores numeric value information in inputting a G code as numeric value information for generating a G code in the terminal memory 23.

The user, upon completion of G code inputs for the program of which the user wants to make a recording, reverses the display of the confirm button on the display section 25 using the navigation key 241. The process involved here is similar to the process performed by the terminal information management section 221 to move the cursor (highlighting of various buttons displayed on the display section 25) in the iEPG; description of the process is therefore omitted.

The terminal information management section 221, upon receiving recording schedule command information representing an input made through the enter key 242 while the confirm button shown in (a) of FIG. 8 is being highlighted, transmits the stored numeric value information as recording schedule information representing a G code to the video recorder 1. Upon receiving the recording schedule information representing a G code, the video recorder 1 receives program information corresponding to the G code, for example, via the tuner section 14, to have the display device 3 display. Specifically, as the device control section 12 in the video recorder 1 receives the recording schedule information representing a G code, the device information management section 122 retrieves G code screen data to have the display device 3 display the screen shown in (b) of FIG. 8 from the device memory 13. Then, the device information management section 122 generates display screen data from the G code screen data and program information corresponding to the G code received via the tuner section 14 so that the display device 3 can display the data and transmits the display screen data to the display device 3.

After checking the program information on the screen shown in (b) of FIG. 8 displayed on the display device 3 (checking that the G code has been correctly input), the user manipulates the navigation key 241 to select one of the record scheduling buttons or the return button displayed on the screen.

The process involved here is similar to the process performed by the terminal information management section 221 to move the cursor.

Then, the terminal information management section 221, upon receiving an input made through the enter key 242 while the screen shown in (b) of FIG. 8 is being displayed on the display device 3, transmits the recording schedule command information representing the input to the video recorder 1. As the device control section 12 in the video recorder 1 receives the recording schedule command information, the device information management section 122 retrieves the screen data corresponding to the functions set up for the record scheduling button and the return button from the device memory 13.

In other words, upon determining that the recording schedule command information representing an input made through the enter key 242 has been received while one of the record scheduling buttons is being highlighted, the device information management section 122 determines that one of the record scheduling buttons has been selected. The device information management section 122 then determines the program information which was used to have the display device 3 display the screen shown in (b) of FIG. 8 as the recording schedule information. In contrast, upon determining that the recording schedule command information representing an input made through the enter key 242 has been received while the return button is being highlighted, the device information management section 122 determines that the return button has been selected, retrieves the screen data representing the screen shown in (a) of FIG. 8 from the device memory 13, and again has the display device 3 display the screen shown in (a) of FIG. 8.

Accordingly, the user can schedule a recording of a desired program in the video recorder 1 by manipulating the input section 24 (especially, the numeric keypad 243) on the personal information terminal 2 through an input of a G code.

Next will be described setting up a scheduled recording on an EPG displayed on the display device 3 connected to the video recorder 1. The device information management section 122 in the video recorder 1 stores in advance the EPG screen data received from the tuner section 14 in the device memory 13 and later retrieves the screen data from the device memory 13. Then, the device information management section 122 has the EPG screen displayed by transmitting the screen data representing the EPG screen shown in (a) of FIG. 9 to the display device 3.

The input section 24 in the personal information terminal 2 receives a command for selecting a program of which the user to make a recording in the video recorder 1 from the program section of the EPG displayed on the display device 3. In other words, the terminal information management section 221, upon receiving recording schedule command information representing an input through the navigation key 241, transmits the recording schedule command information to the video recorder 1. That is, the personal information terminal 2 in so doing may be described as having similar functions to those of a remote controller for manipulating the video recorder 1.

As the device control section 12 in the video recorder 1 receives the recording schedule command information from the personal information terminal 2, the device information management section 122 generates EPG display screen data based on the recording schedule command information and transmits the data to the display device 3. The process of the device information management section 122 generating the EPG display screen data based on the recording schedule command information is described earlier. The description is not repeated here.

The user sees that the highlighted program on the display device 3 shown in (a) of FIG. 9 is the one he/she wants to make a recording in the video recorder 1 and presses the enter key 242. As the enter key 242 is pressed, the terminal information management section 221 receives recording schedule command information representing the input made through the enter key 242 and transmits the recording schedule command information to the video recorder 1. As the device control section 12 in the video recorder 1 receives the recording schedule command information representing the input made through the enter key 242, the device information management section 122 retrieves EPG screen data to have the display device 3 display the screen shown in (b) of FIG. 9. Then, the device information management section 122 generates display screen data to be displayed on the display device 3 from the EPG screen data and the program information for the highlighted program on the EPG screen shown in (a) of FIG. 9 and has the display device 3 display the display screen data.

Next, when the user has confirmed the program information in the screen shown in (b) of FIG. 9 displayed on the display device 3 (confirming that the correct program has been selected), the user selects one of the record scheduling buttons or return button displayed on the screen by manipulating the navigation key 241. The process in this case is similar to the process for the terminal information management section 221 and the device information management section 122 to move a cursor (highlighting of various buttons displayed on the display device 3) when an input made through the navigation key 241 has been received.

Then, an input made through the enter key 242 is received while the screen shown in (b) of FIG. 9 is being displayed on the display device 3, the terminal information management section 221 transmits the recording schedule command information representing the input to the video recorder 1. As the device control section 12 in the video recorder 1 receives the recording schedule command information, the device information management section 122 retrieves from the device memory 13 the screen data corresponding to the functions set up for the record scheduling buttons and the return button.

In other words, if the device information management section 122 has determined that recording schedule command information representing the input made through the enter key 242 has been received while the record scheduling buttons are being highlighted, the section 122 determines that one of the record scheduling buttons has been selected. Then, the device information management section 122 determines the program information when the display device 3 displayed the screen shown in (b) of FIG. 9 as the recording schedule information. In contrast, the device information management section 122, upon determining that recording schedule command information representing the input made through the enter key 242 has been received while the return button is being highlighted, determines that the return button has been selected, retrieves the screen data representing the screen shown in (a) of FIG. 9 from the device memory 13, and again has the display device 3 display the screen shown in (a) of FIG. 9.

Accordingly, even when the EPG is being displayed on the display section 25 in the video recorder 1, the user can schedule a recording of a desirable program in the video recorder 1 by manipulating the input section 24 on the personal information terminal 2.

### Playback in Information Communications System

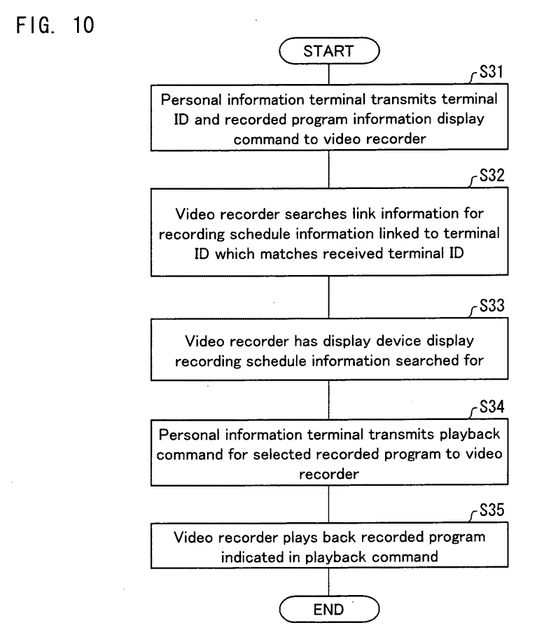

Next will be described a playback process by the video recorder 1 and the personal information terminal 2 in the information communications system 10. FIG. 10 is a flow chart depicting, as an example, a playback process performed by the video recorder 1 and the personal information terminal 2 in the information communications system 10.

First, the terminal information management section 221 in the personal information terminal 2 transmits the terminal ID stored in the terminal memory 23 and a recorded program information display command received by the input section 24 (scheduled recording information list display command) to the video recorder 1 (S31). Specifically, when the user wants to play back a recorded program, the input section 24 receives a recorded program information display command to have the display device 3 display a list of recorded programs and transmits the command to the terminal information management section 221. The terminal information management section 221, upon receiving the recorded program information display command, retrieves the terminal ID stored in the terminal memory 23 and transmits the recorded program information display command and the terminal ID to the video recorder 1 via the terminal-end transmission/reception section 21. The recorded program information display command is a command to have the display device 3 display recorded program information for the programs of which the recordings are completed. Alternatively, the recorded program information display command may be a command to have the display device 3 display recording schedule information for the programs of which the recordings are completed out of all the recording schedule information stored in association with the terminal ID to be transmitted to the video recorder 1 (in other words, broadcast channels, broadcast dates and times, and program titles of the programs of which the recordings are completed as of the scheduling of the recordings).

As the device control section 12 in the video recorder 1 receives the terminal ID and the recorded program information display command via the device-end transmission/reception section 11, the device information management section 122 searches the link information stored in the device memory 13 for the recorded program information or recording schedule information for the program which is linked to the terminal ID which matches the received terminal ID and of which the recording is completed (S32). Then, the device information management section 122 retrieves the recorded program information or recording schedule information that has been found in the search from the device memory 13, generates display screen data to have the display device 3 display the information, and transmits the display screen data to the display device 3. The display device 3 produces a screen display (a display of a recorded program list) based on the display screen data. In other words, the device information management section 122 has the display device 3 display the recorded program information or recording schedule information that has been found in the search (S33). Accordingly, the video recorder 1 can have the display device 3 display the recorded programs corresponding to the personal information terminal 2 from which the recorded program information display command was received in preference to the recorded programs corresponding to the other terminals. In other words, the video recorder 1 can have the display device 3 display only the information for the programs of which the user made recordings in the video recorder 1.

Next, the personal information terminal 2 transmits a playback command for a selected recorded program to the video recorder 1 (S34). Specifically, to select a program the user wants to play back from the recorded programs displayed on the display device 3, the user manipulates the navigation key 241 and the enter key 242. Specifically, upon receiving playback operation information representing the playback operation input made through these buttons, the terminal information management section 221 transmits the playback operation information to the video recorder 1. As the device control section 12 in the video recorder 1 receives the playback operation information, the device information management section 122 selects the recorded program information or recording schedule information based on the playback operation information and determines the recorded program to be played back. In other words, the device information management section 122 determines that the playback operation information representing the input made through the enter key 242 and received by the device control section 12 at that timing is a playback command for the selected recorded program. The process of selecting and determining a program the user wants to play back is similar to the process of selecting the program of which the user wants to make a recording on, for example, the EPG screen shown in (a) of FIG. 9 and scheduling the recording. The description is not repeated here.

The device information management section 122, upon receiving the playback operation information from the personal information terminal 2 and determining a recorded program to be played back, retrieves the recorded program from the device memory 13 and transmits the recorded program to the display device 3. In other words, the video recorder 1 plays back the recorded program for which the playback command was received by transmitting the recorded program to the display device 3 (S35).

From the above description, the user can have the video recorder 1 recognize the program he/she wants to play back by selecting a program he/she wants to play back from the list of the recorded programs displayed on the display device 3 through manipulation of the navigation key 241 and pressing the enter key 242 while the program he/she wants to play back is being highlighted. Accordingly, the video recorder 1 can play back the program which the user wants to play back based on the playback command from the personal information terminal 2.

As described above, the video recorder in accordance with the present invention identifies the personal information terminal being used by the user and can readily have the user recognize only the recording schedule information needed by the user. The video recorder in accordance with the present invention is therefore applicable to the video recorder, containing a hard disk, DVD, Blu-ray disc, or like high-capacity storage medium, which is manipulated through a mobile terminal, such as a mobile phone, a mobile PC, or a PDA (personal digital assistant), that can communicate with the video recorder and that can be carried around by the user.

The recording device in accordance with the present invention may further include reception determining means for determining whether or not the device-end reception means has received the terminal ID set up by the setup means from the information terminal together with either the schedule information or the scheduling command information,

wherein

when the reception determining means determines that the terminal ID has not been received, the setup means sets up an unused terminal ID for either the schedule information received by the device-end reception means or the schedule information determined according to the scheduling command information and transmits the terminal ID to the information terminal.

According to the configuration, when the reception determining means determines that the terminal ID has not been received together with the schedule information or the scheduling command information, the setup means sets up an unused terminal ID for the schedule information and transmits the terminal ID to the information terminal. Accordingly, the recording device can reliably set up a terminal ID for the information terminal from which no terminal ID has been received together with either the schedule information or the scheduling command information. The unused terminal ID is one of terminal IDs stored in the recording device which is not used by the setup means in setting up a terminal ID for schedule information.

The recording device in accordance with the present invention may be such that when the device management means has received from the information terminal a command to transmit a device ID which is information unique to the recording device, the device management means transmits the device ID to the information terminal.

According to the configuration, the recording device, upon receiving a transmission command from the information terminal, transmits the device ID to the information terminal. Accordingly, the recording device can have the information terminal recognize that the recording device is capable of communication. In other words, the information terminal can recognize that the recording device is capable of communication and hence can transmit the schedule information or scheduling command information to, for example, a plurality of recording devices. Therefore, the user can issue record scheduling commands to a plurality of recording devices capable of communication by using a single information terminal.

The recording device in accordance with the present invention may be such that when the device-end reception means has received terminal-specific information which is information unique to the information terminal and unalterable by a user, the device management means manages the terminal-specific information as the terminal ID in association with the schedule information.

According to the configuration, when the information terminal is given terminal-specific information unalterable by the user, the recording device receives the terminal-specific information from the information terminal and manages the terminal-specific information as the terminal ID.

Accordingly, by determining that a terminal ID has been received when the terminal-specific information is received, the recording device can have, for example, a display device connected to the recording device display only the schedule information for the program of which the user has scheduled a recording, without having to have information on either the user who schedules the recording of the program or the information terminal used by the user obtained through inputs from the user on the information terminal.

In addition, by determining that a terminal ID has been received when the terminal-specific information is received, the recording device can manage the information terminal and the schedule information in association with each other without having to set up a terminal ID for the information terminal and transmitting the terminal ID. In other words, the recording device needs no structural arrangement which sets up a terminal ID and transmits the terminal ID to the information terminal, allowing for simplification of the configuration.

The recording device in accordance with the present invention may be such that:

the information terminal is a mobile phone; and

the terminal-specific information received by the device-end reception means is a telephone number for the information terminal.

According to the configuration, the information terminal is a mobile phone. The mobile phone is given a telephone number as terminal-specific information. Accordingly, the recording device can receive the telephone number, which eliminates the need for the user to specify terminal-specific information for the information terminal, and determines that the telephone number has been received as a terminal ID.

The recording device in accordance with the present invention may be such that the device management means encrypts the terminal-specific information for management.

According to the configuration, the recording device encrypts the telephone number, which is personal information highly confidential nature to the user using the mobile phone as the information terminal, before storing it. Therefore, when, for example, the user discards the recording device, the configuration prevents leakage of the telephone number in advance.

The recording device in accordance with the present invention may be such that when the device-end reception means has received a personal ID which is information related to a user of the information terminal, the device management means manages the personal ID and the schedule information in association with each other.

According to the configuration, the recording device, upon receiving a personal ID, manages the personal ID in association with the schedule information. Even if, for example, different information terminals have set up the schedule information, the recording device therefore can have, for example, a display device connected to the recording device display all the schedule information so long as the schedule information is associated with the identical personal ID.

Therefore, for example, even if the user has used a plurality of information terminals to schedule programs, the user can readily recognize the scheduled programs because the programs he/she has scheduled are displayed by the display device.

A information terminal in accordance with the present invention may be such that the device management means has a display device connected to the information terminal display the schedule information for each terminal ID.

According to the configuration, the device management means can manage the terminal ID either received or set up and the schedule information in association with each other and have the display device display the schedule information for each terminal ID. In other words, the recording device can have the display device display only the schedule information for the program of which the user has scheduled a recording, without having to have information on either the user who schedules the recording of the program or the information terminal used by the user obtained through inputs from the user on the information terminal.

Accordingly, the user can view the display on the display device connected to the recording device and recognize the schedule information he/she needs without performing any manipulation other than entering record scheduling commands on the information terminal.

The information terminal and the display device are directly connected, for example, via a cable. This is not the only possibility; for example, the terminal and device may be connected over a network via a hub.

A information terminal in accordance with the present invention is characterized in that it is an information terminal capable of communicating with the recording device described above and includes:

input means for receiving, through inputs from a user, either the schedule information or the scheduling command information representing a command to determine the schedule information to be transmitted to the recording device;

terminal-end reception means for receiving the terminal ID set up by the recording device; and

terminal management means for managing the terminal ID received by the terminal-end reception means and either the schedule information or the scheduling command information received by the input means for transmission to the recording device.

According to the configuration, in the information terminal, the terminal management means manages the terminal ID received by the terminal-end reception means together with either the schedule information or the scheduling command information received by the input means for transmission to the recording device. Accordingly, the recording device can manage the terminal ID received and the schedule information in association with each other.

Accordingly, the information terminal can have, for example, a display device connected to the recording device display only the schedule information for the program of which the user has scheduled a recording, without having to obtain information on either the user who schedules the recording of the program or the information terminal used by the user through inputs from the user and transmitting the information to the recording device.

The information terminal in accordance with the present invention may be such that the terminal management means transmits either the schedule information or the scheduling command information to the recording device from which the information terminal has received a device ID in response to a command to transmit a device ID which is information unique to the recording device.

According to the configuration, the information terminal can recognize the recording device capable of communication by receiving a device ID from the recording device. The information terminal therefore can transmit either the schedule information or the scheduling command information to, for example, a plurality of recording devices. Accordingly, the user can issue record scheduling commands to a plurality of recording devices capable of communication by using a single information terminal.

The information terminal in accordance with the present invention may be such that when the terminal management means has terminal-specific information which is information unique to the information terminal and unalterable by the user, the terminal management means manages the terminal-specific information for transmission to the recording device.

According to the configuration, when the terminal management means has terminal-specific information, the terminal management means transmits the terminal-specific information to the recording device. Upon receiving the terminal-specific information, the recording device determines that it has received a terminal ID.

Accordingly, even when the terminal-specific information is transmitted to the recording device, the information terminal can have, for example, a display device connected to the recording device display only the schedule information for the program of which the user has scheduled a recording, without having to obtain information on either the user who schedules the recording of the program or the information terminal used by the user through inputs from the user and transmitting the information to the recording device.

The information terminal in accordance with the present invention may be such that the information terminal is a mobile phone having a telephone number as the terminal-specific information.

According to the configuration, the information terminal is a mobile phone. The mobile phone is given a telephone number as the terminal-specific information. Accordingly, the information terminal can eliminate the need for the user to specify terminal-specific information for the transmission of the telephone number to the recording device.

The information terminal in accordance with the present invention may be such that when the input means has received a personal ID which is information related to the user of the information terminal, the terminal management means manages the personal ID for transmission to the recording device.

According to the configuration, the information terminal transmits the personal ID received by the input means to the recording device. Therefore, even if, for example, different information terminals have set up the schedule information, the recording device, having received the personal ID, can have, for example, a display device connected to the recording device display all the schedule information so long as the schedule information is associated with the identical personal ID.

Accordingly, for example, even if the user has used a plurality of information terminals to schedule programs, the user can readily recognize the scheduled programs because the programs he/she has scheduled are displayed by the display device.

An information communications system in accordance with the present invention is characterized in that it includes: a recording device described above; and an information terminal described above.

According to the information communications system, the recording device can have, for example, a display device connected to the recording device display only the schedule information for the program of which the user has scheduled a recording, without having to have information on either the user who schedules the recording of the program or the information terminal used by the user obtained through inputs from the user on the information terminal. In other words, the recording device does not need to have the user who schedules the recording of the program using the information terminal perform any manipulation other than entering record scheduling commands; hence, the recording device can readily have the user recognize only the schedule information that he/she needs.

Meanwhile, the information terminal can have the display device display only the schedule information for the program of which the user has scheduled a recording, without having to obtain information on either the user who schedules the recording of the program or the information terminal used by the user through inputs from the user and transmitting the information to the recording device.

The recording device may be implemented on a computer. When that is the case, the scope of the present invention encompasses recording device control programs which, when run on a computer, causes the computer to function as the individual means described above to implement the recording device and also encompasses computer-readable storage media containing such a program.

### Supplementary Description

Finally, the blocks of the video recorder 1 according to the present embodiment, especially, the ID reception determining section 121 and the device information management section 122, and the blocks of the personal information terminal 2 according to the present embodiment, especially, the terminal information management section 221, may be implemented by hardware or software executed by a CPU as follows:

The video recorder 1 and the personal information terminal 2 according to the present embodiment each include a CPU (central processing unit) and memory devices (storage media). The CPU executes instructions contained in control programs, realizing various functions. The memory devices may be a ROM (read-only memory) containing programs, a RAM (random access memory) to which the programs are loaded, or a memory containing the programs and various data. The objective of the present invention can be achieved also by mounting to the video recorder 1 and the personal information terminal 2 a computer-readable storage medium containing control program code (executable programs, intermediate code programs, or source programs) for the video recorder 1 and the personal information terminal 2, which is software realizing the aforementioned functions, in order for a computer (or CPU, MPU) to retrieve and execute the program code contained in the storage medium.

The storage medium may be, for example, a tape, such as a magnetic tape or a cassette tape; a magnetic disk, such as a Floppy® disk or a hard disk, or an optical disc, such as a CD-ROM/MO/MD/DVD/CD-R; a card, such as an IC card (memory card) or an optical card; or a semiconductor memory, such as a mask ROM/EPROM/EEPROM/flash ROM.

The video recorder 1 and the personal information terminal 2 according to the present embodiment may be arranged to be connectable to a communications network so that the program code may be delivered over the communications network. The communications network is not limited in any particular manner, and may be, for example, the Internet, an intranet, extranet, LAN, ISDN, VAN, CATV communications network, virtual dedicated network (virtual private network), telephone line network, mobile communications network, or satellite communications network. The transfer medium which makes up the communications network is not limited in any particular manner, and may be, for example, a wired line, such as IEEE 1394, USB, an electric power line, a cable TV line, a telephone line, or an ADSL; or wireless, such as infrared (IrDA, remote control), Bluetooth®, 802.11 wireless, HDR, a mobile telephone network, a satellite line, or a terrestrial digital network. The present invention encompasses a computer data signal, on a carrier wave, which is embodied in electronic transmission of the program code.

### ALTERNATIVE DESCRIPTION OF THE PRESENT INVENTION

The present invention may be described as follows.

The video recorder in accordance with the present invention is characterized in that it is a video recorder receiving a personal ID of the user who schedules a recording together with recording schedule information for a program, recording the program, and making a record by associating the recording schedule information or recorded program information with a terminal ID, wherein a recording device specifies the terminal ID for a personal information terminal which transmits the recording schedule information.

The video recorder is preferably such that: the video recorder transmits a video recorder-specific device ID number to the personal information terminal; and the personal information terminal transmits a terminal ID number corresponding to a video recorder which matches the device ID number and the recording schedule information to the video recorder.

The video recorder in accordance with the present invention is characterized in that it is a video recorder receiving a personal ID of the user who schedules a recording together with recording schedule information for a program, recording the program, and making a record by associating the recording schedule information or recorded program information with a personal ID, wherein: a personal information terminal has a terminal-specific ID number unalterable by the user; and the terminal-specific ID number is used as terminal-specific information.

The video recorder is preferably such that: the personal information terminal is a mobile phone; and the terminal-specific ID number is a telephone number for the mobile phone.

The video recorder is preferably such that it encrypts the terminal-specific ID number for the personal information terminal before recording the terminal-specific ID number in the recording device.

The video recorder is preferably such that it associates a single set of supplementary personal ID to a plurality of personal IDs.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

1. A recording device recording a program according to schedule information for scheduling a recording of the program, said device comprising:
device-end reception means for receiving either the schedule information or scheduling command information representing a command to determine the schedule information from an information terminal capable of communicating with the recording device;
setup means for setting up a terminal ID by which to identify the information terminal for either the schedule information received by the device-end reception means or the schedule information determined according to the scheduling command information; and
device management means for managing the terminal ID set up by the setup means and the schedule information in association with each other.

2. The recording device as set forth in claim 1, further comprising reception determining means for determining whether or not the device-end reception means has received the terminal ID set up by the setup means from the information terminal together with either the schedule information or the scheduling command information, wherein
when the reception determining means determines that the terminal ID has not been received, the setup means sets up an unused terminal ID for either the schedule information received by the device-end reception means or the schedule information determined according to the scheduling command information and transmits the terminal ID to the information terminal.

3. The recording device as set forth in claim 1, wherein when the device management means has received from the information terminal a command to transmit a device ID which is information unique to the recording device, the device management means transmits the device ID to the information terminal.

4. The recording device as set forth in claim 1, wherein when the device-end reception means has received terminal-specific information which is information unique to the information terminal and unalterable by a user, the device management means manages the terminal-specific information as the terminal ID in association with the schedule information.

5. The recording device as set forth in claim 4, wherein:
the information terminal is a mobile phone; and
the terminal-specific information received by the device-end reception means is a telephone number for the information terminal.

6. The recording device as set forth in claim 4, wherein the device management means encrypts the terminal-specific information for management.

7. The recording device as set forth in claim 1, wherein when the device-end reception means has received a personal ID which is information related to a user of the information terminal, the device management means manages the personal ID and the schedule information in association with each other.

8. The recording device as set forth in claim 1, wherein the device management means has a display device connected to the recording device display the schedule information for each terminal ID.

9. A method of controlling a recording device recording a program according to schedule information for scheduling a recording of the program, said method comprising the steps of:
(a) receiving either the schedule information or scheduling command information representing a command to determine the schedule information from an information terminal capable of communicating with the recording device;
(b) setting up a terminal ID by which to identify the information terminal for either the schedule information received in step (a) or the schedule information determined according to the scheduling command information; and
(c) managing the terminal ID set up in step (b) and the schedule information in association with each other.

10. An information terminal capable of communicating with a recording device as set forth in claim 1, said terminal comprising:
input means for receiving, through inputs from a user, either the schedule information or the scheduling command information representing a command to determine the schedule information to be transmitted to the recording device;
terminal-end reception means for receiving the terminal ID set up by the recording device; and
terminal management means for managing the terminal ID received by the terminal-end reception means and either the schedule information or the scheduling command information received by the input means for transmission to the recording device.

11. The information terminal as set forth in claim 10, wherein the terminal management means transmits either the schedule information or the scheduling command information to the recording device from which the information terminal has received a device ID in response to a command to transmit a device ID which is information unique to the recording device.

12. The information terminal as set forth in claim 10, wherein when the terminal management means has terminal-specific information which is information unique to the information terminal and unalterable by the user, the terminal management means manages the terminal-specific information for transmission to the recording device.

13. The information terminal as set forth in claim 12, wherein the information terminal is a mobile phone having a telephone number as the terminal-specific information.

14. The information terminal as set forth in claim 10, wherein when the input means has received a personal ID which is information related to the user of the information terminal, the terminal management means manages the personal ID for transmission to the recording device.

15. An information communications system, comprising:
a recording device as set forth in claim 1; and
an information terminal as set forth in claim 10.

16. A computer-readable storage medium containing a control program for a recording device as set forth in claim 1 so that a computer functions as each of the means of the recording device.

17. The recording device as set forth in claim 7, wherein the device management means has a display device connected to the recording device display the schedule information for each personal ID.

18. An information communications system, comprising:
a recording device as set forth in claim 3; and
an information terminal as set forth in claim 11.

19. An information communications system, comprising:
a recording device as set forth in claim 7; and
an information terminal as set forth in claim 14.
